(19) United States
(12) Patent Application Publication
(10) Pub. No.: US 2025/0168576 A1
(43) Pub. Date: May 22, 2025

(54) SIGNAL PROCESSING METHOD, APPARATUS, AND DEVICE CONTROL METHOD AND APPARATUS

(71) Applicant: HUAWEI TECHNOLOGIES CO., LTD., Shenzhen (CN)

(72) Inventors: Zhenxia GUI, Hangzhou (CN); Fan FAN, Shenzhen (CN); Tianxiang CAO, Hangzhou (CN)

(21) Appl. No.: 19/029,719

(22) Filed: Jan. 17, 2025

Related U.S. Application Data
(63) Continuation of application No. PCT/CN2023/093251, filed on May 10, 2023.

(30) Foreign Application Priority Data
Jul. 30, 2022 (CN) 202210911626.2

(51) Int. Cl. H04R 25/00

(52) U.S. Cl. CPC H04R 25/505; H04R 2225/43

(57) ABSTRACT

Embodiments of this application provide example signal processing methods, example apparatuses, and example device control methods and apparatuses. One example signal processing method is applied to a hearing aid apparatus. The method includes collecting a first signal and a second signal if it is detected that a user wears the hearing aid apparatus and the user makes a sound, where the first signal includes a self-speaking voice of the user and an ambient sound, and the second signal includes a sound signal of the user.

### CROSS-REFERENCE TO RELATED APPLICATIONS

This application is a continuation of International Application No. PCT/CN2023/093251, filed on May 10, 2023, which claims priority to Chinese Patent Application No. 202210911626.2, filed on Jul. 30, 2022. The disclosures of the aforementioned applications are hereby incorporated by reference in their entireties.

### TECHNICAL FIELD

Embodiments of this application relate to the multimedia field, and in particular, to a signal processing method, an apparatus, and a device control method and apparatus.

### BACKGROUND

With development of technologies, a hearing aid apparatus, such as a device like a headset or a hearing aid, can meet a requirement of interaction with a real world by a user. The user can hear, via the hearing aid apparatus, a sound of the user, that is, a self-speaking voice and an external ambient sound. In a specific application, a speaker of the hearing aid apparatus is located in an ear of the user. As a result, the self-speaking voice heard by the user is not natural enough, for example, a problem that the sound is dull or loud exists.

In a related technology, to make the self-speaking voice heard by the user more natural, an original in-ear signal played in the ear by the speaker of the hearing aid apparatus is usually collected, a phase and an amplitude of the original in-ear signal are adjusted, and an adjusted in-ear signal and the original in-ear signal are played at the same time. In this way, the played adjusted in-ear signal may cancel out the played original in-ear signal, so that noise reduction is implemented and the problem that the self-speaking voice is dull and loud is relieved.

However, in this manner, not only the self-speaking voice included in the original in-ear signal is canceled out, but also the ambient sound included in the original in-ear signal is canceled out. Consequently, the user cannot perceive the external ambient sound.

### SUMMARY

This application provides a signal processing method, an apparatus, and a device control method and apparatus, so that a hearing aid apparatus pertinently processes a sound signal of a user in a first signal based on the first signal and the sound signal of the user. This avoids cancellation of an ambient sound signal in the first signal, and implements that the self-speaking sound that is of the user and that is heard by the user is more natural and the user may perceive an ambient sound.

According to a first aspect, an embodiment of this application provides a signal processing method, applied to a hearing aid apparatus, where the method includes: collecting a first signal and a second signal when it is detected that a user wears the hearing aid apparatus and the user makes a sound, where the first signal includes a sound signal of the user and a surrounding ambient sound signal, and the second signal includes the sound signal of the user; processing the sound signal of the user in the first signal based on the first signal and the second signal, to obtain a target signal; and playing the target signal through an ear speaker.

In this embodiment of this application, the first signal collected via the hearing aid apparatus includes a self-speaking voice of the user and an ambient sound, and the second signal includes the sound signal of the user. In this way, the hearing aid apparatus may pertinently process the sound signal of the user in the first signal based on the first signal and the second signal, to obtain the target signal, and play the target signal through the ear speaker in the hearing aid apparatus, so that cancellation of an ambient sound signal in the first signal can be avoided, and that the self-speaking sound that is of the user and that is heard by the user is more natural and the user may perceive the ambient sound can be implemented.

According to the first aspect, the processing the sound signal of the user in the first signal based on the first signal and the second signal, to obtain a target signal includes: filtering the first signal based on the second signal, to obtain a filtering gain; and performing attenuation processing on the sound signal of the user in the first signal based on the filtering gain, to obtain the target signal.

In this embodiment of this application, the first signal is filtered based on the second signal, to obtain the filtering gain, so that it can be ensured that the filtering gain can be used to attenuate the sound signal of the user in the first signal, to obtain the target signal through attenuation processing. In this way, the sound signal of the user in the target signal is attenuated, so that a problem of dull hearing perception of the sound of the user in the played target signal can be reduced, and the hearing perception is more natural. Therefore, that the self-speaking sound that is of the user and that is heard by the user is more natural and the user may perceive the ambient sound is implemented.

According to the first aspect or any one of the implementations of the first aspect, the filtering the first signal based on the second signal, to obtain a filtering gain includes: filtering the sound signal of the user in the first signal based on the second signal, to obtain an expected signal; and calculating a ratio of the expected signal to the first signal, to obtain the filtering gain.

In this embodiment of this application, the filtering gain is obtained based on the ratio of the expected signal to the first signal, and the expected signal is a signal that meets an expectation of attenuation processing on the second signal in the first signal, so that accuracy of the filtering gain can be ensured. Based on this, attenuation processing performed based on the filtering gain may be more accurate.

According to the first aspect or any one of the implementations of the first aspect, the filtering the first signal based on the second signal, to obtain a filtering gain includes: filtering the first signal based on the second signal, to obtain an original filtering gain; obtaining at least one of a degree correction amount and a frequency band range; and adjusting a magnitude of the original filtering gain based on the degree correction amount, to obtain the filtering gain; and/or adjusting, based on the frequency band range, a frequency band on which the original filtering gain is enabled, to obtain the filtering gain.

In this embodiment of this application, the magnitude of the filtering gain is adjusted based on the degree correction amount, and then an attenuation degree of the sound signal of the user in the first signal is adjusted based on an adjusted filtering gain. The frequency band on which the filtering gain is enabled is adjusted based on the frequency band range, and then a frequency band of the attenuated sound signal of the user in the first signal is adjusted based on the adjusted filtering gain. Therefore, a more flexible and customized signal processing effect may be implemented through adjustment in this embodiment, but not limited to a fixed signal processing effect.

According to the first aspect or any one of the implementations of the first aspect, the processing the sound signal of the user in the first signal based on the first signal and the second signal, to obtain a target signal includes: enhancing the first signal based on the second signal, to obtain a compensated signal; and performing enhancement processing on the sound signal of the user in the first signal based on the compensated signal, to obtain the target signal.

In this embodiment of this application, the first signal is enhanced based on the second signal, to obtain the compensated signal, so that it can be ensured that the compensated signal can be used to enhance the sound signal of the user in the first signal, to obtain the target signal through enhancement processing. In this way, the sound signal of the user in the target signal is enhanced, so that a problem of not full hearing perception of the sound of the user in the played target signal can be reduced, and the hearing perception is more natural. Therefore, that the self-speaking sound that is of the user and that is heard by the user is more natural and the user may perceive the ambient sound is implemented.

According to the first aspect or any one of the implementations of the first aspect, the enhancing the first signal based on the second signal, to obtain a compensated signal includes: determining a weighting coefficient of the second signal; obtaining an enhanced signal based on the weighting coefficient and the second signal; and loading the enhanced signal to the first signal, to obtain the compensated signal.

In this embodiment of this application, the enhanced signal is obtained based on the weighting coefficient of the second signal and the second signal, so that it can be ensured that the enhanced signal is a signal in which the second signal is enhanced, that is, the sound signal of the user. The enhanced signal is loaded to the first signal, to obtain the compensated signal, so that it can be ensured that the compensated signal can be used to perform enhancement processing on the sound signal of the user in the first signal.

According to the first aspect or any one of the implementations of the first aspect, the enhancing the first signal based on the second signal, to obtain a compensated signal includes: obtaining at least one of a degree correction amount and a frequency band range; and enhancing the first signal based on signal compensation strength indicated by the degree correction amount and the second signal, to obtain the compensated signal; and/or enhancing, based on the second signal, the first signal belonging to the frequency band range, to obtain the compensated signal.

In this embodiment of this application, the compensation strength for the compensated signal is adjusted based on the degree correction amount, and then the enhancement degree of the sound signal of the user in the first signal is adjusted based on an adjusted compensated signal. The frequency band of the enhanced compensated signal is adjusted based on the frequency band range, and then the frequency band of the enhanced sound signal of the user in the first signal is adjusted based on the adjusted compensated signal. Therefore, a more flexible and customized signal processing effect of signal processing may be implemented through adjustment in this embodiment, but not limited to a fixed signal processing effect.

According to the first aspect or any one of the implementations of the first aspect, the obtaining at least one of a degree correction amount and a frequency band range includes: establishing a communication connection to a target terminal, where the target terminal is configured to display a parameter adjustment interface, and the parameter adjustment interface includes at least one of the following setting controls: an adjustment degree setting control and a frequency band range setting control; and receiving at least one of the degree correction amount and the frequency band range that are sent by the target terminal, where the degree correction amount and the frequency band range are obtained by the target terminal by detecting an operation on the adjustment degree setting control and an operation on the frequency band range setting control.

In this embodiment of this application, the hearing aid apparatus establishes the communication connection to the target terminal, and the user may operate at least one of the adjustment degree setting control and the frequency band range setting control on the parameter adjustment interface displayed on the target terminal, to set at least one of the attenuation degree of the attenuation processing of the hearing aid apparatus and the frequency band range of the attenuated sound signal, so that the attenuation effect, that is, a self-speaking suppression effect, is obtained, customized signal processing is implemented, and user experience is further improved.

According to the first aspect or any one of the implementations of the first aspect, the parameter adjustment interface includes a left-ear adjustment interface and a right-ear adjustment interface; and the receiving at least one of the degree correction amount and the frequency band range that are sent by the target terminal includes: receiving at least one of left-ear correction data and right-ear correction data that are sent by the target terminal, where the left-ear correction data is obtained by the target terminal by detecting an operation on a setting control on the left-ear adjustment interface, and the right-ear correction data is obtained by the target terminal by detecting an operation on a setting control on the right-ear adjustment interface; the left-ear correction data includes at least one of a left-ear degree correction amount and a left-ear frequency band range; and the right-ear correction data includes at least one of a right-ear degree correction amount and a right-ear frequency band range; and selecting, based on an ear identifier carried in the left-ear correction data and/or the right-ear correction data, correction data corresponding to an ear that is the same as an ear in which the hearing aid apparatus is located.

In this embodiment of this application, based on the left-ear adjustment interface and the right-ear adjustment interface of the target terminal, the user may set different parameters for two headsets on the left and right ears, to match an ear difference or meet requirements of different applications, so that accuracy of the customized effect of signal processing is further improved, and user experience is further improved.

According to the first aspect or any one of the implementations of the first aspect, the target terminal is further configured to display a mode selection interface, where the mode selection interface includes a self-speaking optimization mode selection control; and before the collecting a first signal and a second signal, the method further includes: when a self-speaking optimization mode enable signal sent by the target terminal is received, detecting whether the user wears the hearing aid apparatus, where the self-speaking optimization mode enable signal is sent when the target terminal detects an enable operation on the self-speaking optimization mode selection control; and if the user wears the hearing aid apparatus, detecting whether the user makes the sound.

In this embodiment of this application, based on the self-speaking optimization mode selection control of the target terminal, the user may perform an operation of enabling a self-speaking optimization mode. When the user enables the self-speaking optimization mode of the hearing aid apparatus, the hearing aid apparatus detects whether the user wears the hearing aid apparatus, and further detects whether the user makes the sound when the user wears the hearing aid apparatus. In this way, the user can autonomously determine whether to perform the signal processing provided in embodiments of this application, so that user experience is further improved.

According to the first aspect or any one of the implementations of the first aspect, the collecting a first signal and a second signal when it is detected that a user wears the hearing aid apparatus and the user makes a sound includes: detecting, via a first sensor, whether the user wears the hearing aid apparatus; detecting, via a third sensor, whether the user is in a quiet environment if the user wears the hearing aid apparatus; detecting, via a second sensor, whether the user makes the sound if the user is in the quiet environment; and collecting the first signal and the second signal if the user makes the sound.

In this embodiment of this application, the first sensor is used to detect whether the user wears the hearing aid apparatus. When the user wears the hearing aid apparatus, the third sensor is used to detect whether the user is in the quiet environment. Further, when the user is in the quiet environment, the second sensor is used to detect whether the user makes the sound. In this way, it can be ensured that the steps in this embodiment of this application are performed when the user wears the hearing aid apparatus, so that ineffective processing when the user does not wear the hearing aid apparatus is avoided. When the user is in the quiet environment, it is detected whether the user makes the sound, and then the sound signal of the user is collected. In this way, the ambient sound in the signal can be reduced, so that the sound signal of the user better meets the sound of the user.

According to the first aspect or any one of the implementations of the first aspect, the processing the sound signal of the user in the first signal based on the first signal and the second signal, to obtain a target signal includes: collecting a third signal at an ear canal of the user; playing the first signal and the third signal in an ear of the user; collecting a fourth signal and a fifth signal, where the fourth signal includes a signal obtained by mapping the first signal by the ear canal, and the fifth signal includes a signal obtained by mapping the third signal by the ear canal; determining a frequency response difference between the fourth signal and the fifth signal; and processing the sound signal of the user in the first signal based on the first signal, the second signal, and the frequency response difference, to obtain the target signal, where the frequency response difference indicates a degree of processing.

In this embodiment of this application, the first signal and the third signal are played in the ear of the user, to obtain the fourth signal obtained by mapping the first signal by the ear canal, and the fifth signal obtained by mapping the third signal by the ear canal. In this way, the frequency response difference between the fourth signal and the fifth signal may be determined. The frequency response difference may reflect an ear canal structure of the user, so that a signal processing result applicable to the ear canal structure of the user may be obtained based on the first signal, the second signal, and the frequency response difference. Therefore, customized accuracy of signal processing is further improved, it is ensured that the signal processing result is more suitable for the user, and user experience is further improved.

According to the first aspect or any one of the implementations of the first aspect, the determining a frequency response difference between the fourth signal and the fifth signal includes: obtaining a frequency response of the fourth signal and a frequency response of the fifth signal; and calculating a difference value between the frequency response of the fourth signal and the frequency response of the fifth signal, to obtain the frequency response difference.

In this embodiment of this application, the frequency response difference between the fourth signal and the fifth signal may be obtained by calculating the difference between the frequency response of the fourth signal and the frequency response of the fifth signal.

According to the first aspect or any one of the implementations of the first aspect, the processing the sound signal of the user in the first signal based on the first signal, the second signal, and the frequency response difference, to obtain the target signal includes: determining, based on the frequency response difference, that a processing type is attenuation or enhancement; and when the processing type is attenuation, performing attenuation processing on the sound signal of the user in the first signal based on the frequency response difference, to obtain the target signal; or when the processing type is enhancement, performing enhancement processing on the sound signal of the user in the first signal based on the frequency response difference, to obtain the target signal.

In this embodiment of this application, the processing type performed when the sound signal of the user in the first signal is processed may be determined based on the frequency response difference, and then processing suitable for a signal processing requirement is performed based on the processing type, to achieve a more accurate signal processing result.

According to the first aspect or any one of the implementations of the first aspect, the detecting, via a first sensor, whether the user wears the hearing aid apparatus includes: establishing the communication connection to the target terminal, where the target terminal is configured to display the mode selection interface, and the mode selection interface includes a customized mode selection control; and when a customized mode enable signal sent by the target terminal is received, detecting, via the first sensor, whether the user wears the hearing aid apparatus, where the customized mode enable signal is sent when the target terminal detects an enable operation on the customized mode selection control.

In this embodiment of this application, the hearing aid apparatus establishes the communication connection to the target terminal, and the user may control, based on the customized mode selection control on the mode selection interface of the target terminal, whether the customized mode of the hearing aid apparatus is enabled. When the user enables the customized mode, the hearing aid apparatus detects whether the user wears the hearing aid apparatus. In this way, the user can autonomously determine whether to perform signal processing that is based on the sound signal of the user collected in the quiet environment and that is provided in embodiments of this application, so that user experience is further improved.

According to the first aspect or any one of the implementations of the first aspect, the detecting, via a second sensor, whether the user makes the sound if the user is in the quiet environment includes: sending an information display instruction to the target terminal if the user is in the quiet environment, where the information display instruction indicates the target terminal to display prompt information, and the prompt information is used to guide the user to make a sound; and detecting, via the second sensor, whether the user makes the sound.

In this embodiment of this application, when detecting that the user is in the quiet environment, the hearing aid apparatus sends the information display instruction to the target terminal. In this way, the target terminal may display the prompt information when receiving the information display instruction, to guide the user to make a sound based on the prompt information, so that signal processing can be performed more efficiently.

According to the first aspect or any one of the implementations of the first aspect, before the collecting a first signal and a second signal, the method further includes: when it is detected that the user wears the hearing aid apparatus, sending a first completion instruction to the target terminal, where the first completion instruction indicates the target terminal to output prompt information indicating that wearing detection is completed; and when it is detected that the user is in the quiet environment, sending a second completion instruction to the target terminal, where the second completion instruction indicates the target terminal to output information indicating that quiet environment detection is completed; and/or when the target signal is obtained, sending a third completion instruction to the target terminal, where the third completion instruction indicates the target terminal to output at least one piece of the following information: information indicating that detection is completed and information indicating that a customized parameter is generated.

In this embodiment of this application, the hearing aid apparatus may indicate, by sending at least one of the first completion instruction, the second completion instruction, and the third completion instruction to the target terminal, the target terminal to correspondingly output at least one of the following information: the prompt information indicating that wearing detection is completed, the information indicating that quiet environment detection is completed, the information indicating that detection is completed, and information indicating that a customized parameter is generated. In this way, the user can intuitively determine an information processing progress based on the information output by the target terminal, so that user experience is further improved.

According to the first aspect or any one of the implementations of the first aspect, after the playing the target signal through a speaker, the method further includes: performing the step of detecting, via the first sensor, whether the user wears the hearing aid apparatus.

In this embodiment of this application, after playing the target signal through the speaker, the hearing aid apparatus performs the step of detecting, via the first sensor, whether the user wears the hearing aid apparatus. In a process in which the user uses the hearing aid apparatus, based on detection of whether the user is in the quiet environment, a current sound signal of the user is collected in real time, and then the first signal is processed in real time. In this way, the signal processing effect can be adjusted in real time in the wearing process, so that it is ensured that the processing effect better matches a current sound status of the user, and a better processing effect is achieved.

According to the first aspect or any one of the implementations of the first aspect, the detecting, via the first sensor, whether the user wears the hearing aid apparatus includes: establishing the communication connection to the target terminal, where the target terminal is configured to display the mode selection interface, and the mode selection interface includes an adaptive mode selection control; and when an adaptive mode enable signal sent by the target terminal is received, performing the step of detecting, via the first sensor, whether the user wears the hearing aid apparatus, where the adaptive mode enable signal is sent when the target terminal detects an enable operation on the adaptive mode selection control.

In this embodiment of this application, the hearing aid apparatus establishes the communication connection to the target terminal, and the user may control, based on the adaptive mode selection control on the mode selection interface of the target terminal, whether the adaptive mode of the hearing aid apparatus is enabled. When the user enables the adaptive mode, the hearing aid apparatus detects whether the user wears the hearing aid apparatus. In this way, the user can autonomously determine whether to perform the solution of adjusting the signal processing effect in real time in the wearing process provided in embodiments of this application, so that user experience is further improved.

According to a second aspect, an embodiment of this application provides a device control method, applied to a terminal, where the method includes: establishing a communication connection to a hearing aid apparatus, where the hearing aid apparatus is configured to perform the signal processing method according to the first aspect or any one of the implementations of the first aspect; displaying a parameter adjustment interface, where the parameter adjustment interface includes at least one of the following setting controls: an adjustment degree setting control and a frequency band range setting control; detecting an operation on the adjustment degree setting control and an operation on the frequency band range setting control, to obtain at least one of a degree correction amount and a frequency band range; and sending at least one of the degree correction amount and the frequency band range to the hearing aid apparatus, where the hearing aid apparatus processes a sound signal of a user in a first signal based on at least one of the degree correction amount and the frequency band range, to obtain a target signal.

According to the second aspect, the adjustment degree setting control includes a plurality of geometric graphs that are of a same shape but have different dimensions, each of the plurality of geometric graphs indicates a correction amount, and a larger correction amount indicates a larger dimension of the geometric graph; and the frequency band range setting control includes a frequency band range icon and a slider located on the frequency band range icon. Correspondingly, the detecting an operation on the adjustment degree setting control and an operation on the frequency band range setting control, to obtain at least one of a degree correction amount and a frequency band range includes: detecting a tap operation on the plurality of geometric graphs on the adjustment degree setting control; and determining, as the degree correction amount, a correction amount indicated by the geometric graph on which the tap operation is detected; and/or detecting a sliding operation on the slider on the frequency band range setting control; and determining the frequency band range based on a sliding location of the slider.

For example, a shape of the geometric graph may be a rectangle, a circle, a hexagon, or the like. Different geometric graphs have different dimensions. In other words, different geometric graphs may have different heights, different widths, different diameters, and the like. A larger correction amount indicates a larger dimension of a geometric graph. For example, a larger correction amount indicates a higher height of a rectangle, a larger correction amount indicates a longer diameter of a circle, or the like.

According to the second aspect or any one of the implementations of the second aspect, the parameter adjustment interface includes a left-ear adjustment interface and a right-ear adjustment interface. Correspondingly, the detecting an operation on the adjustment degree setting control and an operation on the frequency band range setting control, to obtain at least one of a degree correction amount and a frequency band range includes: detecting an operation on a setting control on the left-ear adjustment interface, to obtain left-ear correction data, where the left-ear correction data includes at least one of a left-ear degree correction amount and a left-ear frequency band range; and detecting an operation on a setting control on the right-ear adjustment interface, to obtain right-ear correction data, where the right-ear correction data includes at least one of a right-ear degree correction amount and a right-ear frequency band range.

According to the second aspect or any one of the implementations of the second aspect, the displaying a parameter adjustment interface includes: displaying a mode selection interface, where the mode selection interface includes a self-speaking optimization mode selection control; and when an enable operation on the self-speaking optimization mode selection control is detected, displaying the parameter adjustment interface.

According to the second aspect or any one of the implementations of the second aspect, before the displaying a parameter adjustment interface, the method further includes: displaying the mode selection interface, where the mode selection interface includes at least one of a customized mode selection control and an adaptive mode selection control; and when an enable operation on the customized mode selection control is detected, sending a customized mode enable signal to the hearing aid apparatus, where the customized mode enable signal indicates the hearing aid apparatus to detect, via a first sensor, whether the user wears the hearing aid apparatus; and/or when an enable operation on the adaptive mode selection control is detected, sending an adaptive mode enable signal to the hearing aid apparatus, where the adaptive mode enable signal indicates the hearing aid apparatus to detect, via the first sensor, whether the user wears the hearing aid apparatus.

According to the second aspect or any one of the implementations of the second aspect, after the sending a customized mode enable signal to the hearing aid apparatus, the method further includes: receiving an information display instruction sent by the hearing aid apparatus, where the information display instruction is sent by the hearing aid apparatus when detecting that the user is in a quiet environment; and displaying prompt information, where the prompt information is used to guide the user to make a sound.

According to the second aspect or any one of the implementations of the second aspect, before the displaying prompt information, the method further includes: receiving a first completion instruction sent by the hearing aid apparatus, where the first completion instruction is sent by the hearing aid apparatus when detecting that the user wears the hearing aid apparatus; and receiving a second completion instruction sent by the hearing aid apparatus, where the second completion instruction is sent by the hearing aid apparatus when detecting that the user is in the quiet environment. Correspondingly, after the displaying prompt information, the method further includes: receiving a third completion instruction sent by the hearing aid apparatus, where the third completion instruction is sent by the hearing aid apparatus when the hearing aid apparatus obtains the target signal; and outputting at least one piece of the following information: information indicating that detection is completed and information indicating that a customized parameter is generated.

The second aspect and any one of the implementations of the second aspect respectively correspond to the first aspect and any one of the implementations of the first aspect. For technical effects corresponding to the second aspect and any one of the implementations of the second aspect, refer to technical effects corresponding to the first aspect and any one of the implementations of the first aspect. Details are not described herein again.

According to a third aspect, an embodiment of this application provides a hearing aid apparatus, where the apparatus includes: a signal collection module, configured to collect a first signal and a second signal when it is detected that a user wears the hearing aid apparatus and the user makes a sound, where the first signal includes a sound signal of the user and a surrounding ambient sound signal, and the second signal includes the sound signal of the user; a signal processing module, configured to process the sound signal of the user in the first signal based on the first signal and the second signal, to obtain a target signal; and a signal output module, configured to play the target signal through an ear speaker.

According to the third aspect, the signal processing module is further configured to: filter the first signal based on the second signal, to obtain a filtering gain; and perform attenuation processing on the sound signal of the user in the first signal based on the filtering gain, to obtain the target signal.

According to the third aspect or any one of the implementations of the third aspect, the signal processing module is further configured to: filter the sound signal of the user in the first signal based on the second signal, to obtain an expected signal; and calculate a ratio of the expected signal to the first signal, to obtain the filtering gain.

According to the third aspect or any one of the implementations of the third aspect, the signal processing module is further configured to: filter the first signal based on the second signal, to obtain an original filtering gain; obtain at least one of a degree correction amount and a frequency band range; and adjust a magnitude of the original filtering gain based on the degree correction amount, to obtain the filtering gain; and/or adjust, based on the frequency band range, a frequency band on which the original filtering gain is enabled, to obtain the filtering gain.

According to the third aspect or any one of the implementations of the third aspect, the signal processing module is further configured to: enhance the first signal based on the second signal, to obtain a compensated signal; and perform enhancement processing on the sound signal of the user in the first signal based on the compensated signal, to obtain the target signal.

According to the third aspect or any one of the implementations of the third aspect, the signal processing module is further configured to: determine a weighting coefficient of the second signal; obtain an enhanced signal based on the weighting coefficient and the second signal; and load the enhanced signal to the first signal, to obtain the compensated signal.

According to the third aspect or any one of the implementations of the third aspect, the signal processing module is further configured to: obtain at least one of a degree correction amount and a frequency band range; and enhance the first signal based on signal compensation strength indicated by the degree correction amount and the second signal, to obtain the compensated signal; and/or enhance, based on the second signal, the first signal belonging to the frequency band range, to obtain the compensated signal.

According to the third aspect or any one of the implementations of the third aspect, the signal processing module is further configured to: establish a communication connection to a target terminal, where the target terminal is configured to display a parameter adjustment interface, and the parameter adjustment interface includes at least one of the following setting controls: an adjustment degree setting control and a frequency band range setting control; and receive at least one of the degree correction amount and the frequency band range that are sent by the target terminal, where the degree correction amount and the frequency band range are obtained by the target terminal by detecting an operation on the adjustment degree setting control and an operation on the frequency band range setting control.

According to the third aspect or any one of the implementations of the third aspect, the parameter adjustment interface includes a left-ear adjustment interface and a right-ear adjustment interface; and the signal processing module is further configured to: receive at least one of left-ear correction data and right-ear correction data that are sent by the target terminal, where the left-ear correction data is obtained by the target terminal by detecting an operation on a setting control on the left-ear adjustment interface, and the right-ear correction data is obtained by the target terminal by detecting an operation on a setting control on the right-ear adjustment interface; the left-ear correction data includes at least one of a left-ear degree correction amount and a left-ear frequency band range; and the right-ear correction data includes at least one of a right-ear degree correction amount and a right-ear frequency band range; and select, based on an ear identifier carried in the left-ear correction data and/or the right-ear correction data, correction data corresponding to an ear that is the same as an ear in which the hearing aid apparatus is located.

According to the third aspect or any one of the implementations of the third aspect, the target terminal is further configured to display a mode selection interface, where the mode selection interface includes a self-speaking optimization mode selection control; and the signal collection module is further configured to: when a self-speaking optimization mode enable signal sent by the target terminal is received, detect whether the user wears the hearing aid apparatus, where the self-speaking optimization mode enable signal is sent when the target terminal detects an enable operation on the self-speaking optimization mode selection control; and if the user wears the hearing aid apparatus, detect whether the user makes the sound.

According to the third aspect or any one of the implementations of the third aspect, the signal collection module is further configured to: detect, via a first sensor, whether the user wears the hearing aid apparatus; detect, via a third sensor, whether the user is in a quiet environment if the user wears the hearing aid apparatus; detect, via a second sensor, whether the user makes the sound if the user is in the quiet environment; and collect the first signal and the second signal if the user makes the sound.

According to the third aspect or any one of the implementations of the third aspect, the signal processing module is further configured to: collect a third signal at an ear canal of the user; play the first signal and the third signal in an ear of the user; collect a fourth signal and a fifth signal, where the fourth signal includes a signal obtained by mapping the first signal by the ear canal, and the fifth signal includes a signal obtained by mapping the third signal by the ear canal; determine a frequency response difference between the fourth signal and the fifth signal; and process the sound signal of the user in the first signal based on the first signal, the second signal, and the frequency response difference, to obtain the target signal, where the frequency response difference indicates a degree of processing.

According to the third aspect or any one of the implementations of the third aspect, the signal processing module is further configured to: obtain a frequency response of the fourth signal and a frequency response of the fifth signal; and calculate a difference value between the frequency response of the fourth signal and the frequency response of the fifth signal, to obtain the frequency response difference.

According to the third aspect or any one of the implementations of the third aspect, the signal processing module is further configured to: determine, based on the frequency response difference, that a processing type is attenuation or enhancement; and when the processing type is attenuation, perform attenuation processing on the sound signal of the user in the first signal based on the frequency response difference, to obtain the target signal; or when the processing type is enhancement, perform enhancement processing on the sound signal of the user in the first signal based on the frequency response difference, to obtain the target signal.

According to the third aspect or any one of the implementations of the third aspect, the signal collection module is further configured to: establish the communication connection to the target terminal, where the target terminal is configured to display the mode selection interface, and the mode selection interface includes a customized mode selection control; and when a customized mode enable signal sent by the target terminal is received, detect, via the first sensor, whether the user wears the hearing aid apparatus, where the customized mode enable signal is sent when the target terminal detects an enable operation on the customized mode selection control.

According to the third aspect or any one of the implementations of the third aspect, the signal collection module is further configured to send an information display instruction to the target terminal if the user is in the quiet environment, where the information display instruction indicates the target terminal to display prompt information, and the prompt information is used to guide the user to make the sound; and detect, via the second sensor, whether the user makes the sound.

According to the third aspect or any one of the implementations of the third aspect, the apparatus further includes an instruction sending module, configured to: when it is detected that the user wears the hearing aid apparatus, send a first completion instruction to the target terminal, where the first completion instruction indicates the target terminal to output prompt information indicating that wearing detection is completed; and when it is detected that the user is in the quiet environment, send a second completion instruction to the target terminal, where the second completion instruction indicates the target terminal to output information indicating that quiet environment detection is completed; and/or when the target signal is obtained, send a third completion instruction to the target terminal, where the third completion instruction indicates the target terminal to output at least one piece of the following information: information indicating that detection is completed and information indicating that a customized parameter is generated.

According to the third aspect or any one of the implementations of the third aspect, the signal collection module is further configured to: after the signal output module plays the target signal through the speaker, perform the step of detecting, via the first sensor, whether the user wears the hearing aid apparatus.

According to the third aspect or any one of the implementations of the third aspect, the signal collection module is further configured to: establish the communication connection to the target terminal, where the target terminal is configured to display the mode selection interface, and the mode selection interface includes an adaptive mode selection control; and when an adaptive mode enable signal sent by the target terminal is received, perform the step of detecting, via the first sensor, whether the user wears the hearing aid apparatus, where the adaptive mode enable signal is sent when the target terminal detects an enable operation on the adaptive mode selection control.

The third aspect and any one of the implementations of the third aspect respectively correspond to the first aspect and any one of the implementations of the first aspect. For technical effects corresponding to the third aspect and any one of the implementations of the third aspect, refer to technical effects corresponding to the first aspect and any one of the implementations of the first aspect. Details are not described herein again.

According to a fourth aspect, an embodiment of this application provides a device control apparatus, used in a terminal, where the apparatus includes: a communication module, configured to establish a communication connection to a hearing aid apparatus, where the hearing aid apparatus is configured to perform the signal processing method according to the first aspect or any one of the implementations of the first aspect; an interaction module, configured to display a parameter adjustment interface, where the parameter adjustment interface includes at least one of the following setting controls: an adjustment degree setting control and a frequency band range setting control; a detection module, configured to detect an operation on the adjustment degree setting control and an operation on the frequency band range setting control, to obtain at least one of a degree correction amount and a frequency band range; and a control module, configured to send at least one of the degree correction amount and the frequency band range to the hearing aid apparatus, where the hearing aid apparatus processes a sound signal of a user in a first signal based on at least one of the degree correction amount and the frequency band range, to obtain a target signal.

According to the fourth aspect, the adjustment degree setting control includes a plurality of geometric graphs that are of a same shape but have different dimensions, each of the plurality of geometric graphs indicates a correction amount, and a larger correction amount indicates a larger dimension of the geometric graph; and the frequency band range setting control includes a frequency band range icon and a slider located on the frequency band range icon. The detection module is further configured to: detect a tap operation on the plurality of geometric graphs on the adjustment degree setting control; and determine, as the degree correction amount, a correction amount indicated by the geometric graph on which the tap operation is detected; and/or detect a sliding operation on the slider on the frequency band range setting control; and determine the frequency band range based on a sliding location of the slider.

According to the fourth aspect or any one of the implementations of the fourth aspect, the parameter adjustment interface includes a left-ear adjustment interface and a right-ear adjustment interface. The detection module is further configured to: detect an operation on a setting control on the left-ear adjustment interface, to obtain left-ear correction data, where the left-ear correction data includes at least one of a left-ear degree correction amount and a left-ear frequency band range; and detect an operation on a setting control on the right-ear adjustment interface, to obtain right-ear correction data, where the right-ear correction data includes at least one of a right-ear degree correction amount and a right-ear frequency band range.

According to the fourth aspect or any one of the implementations of the fourth aspect, the interaction module is further configured to: display a mode selection interface, where the mode selection interface includes a self-speaking optimization mode selection control; and when an enable operation on the self-speaking optimization mode selection control is detected, display the parameter adjustment interface.

According to the fourth aspect or any one of the implementations of the fourth aspect, the interaction module is further configured to: before displaying the parameter adjustment interface, display the mode selection interface, where the mode selection interface includes at least one of a customized mode selection control and an adaptive mode selection control; and when an enable operation on the customized mode selection control is detected, send a customized mode enable signal to the hearing aid apparatus, where the customized mode enable signal indicates the hearing aid apparatus to detect, via a first sensor, whether the user wears the hearing aid apparatus; and/or when an enable operation on the adaptive mode selection control is detected, send an adaptive mode enable signal to the hearing aid apparatus, where the adaptive mode enable signal indicates the hearing aid apparatus to detect, via the first sensor, whether the user wears the hearing aid apparatus.

According to the fourth aspect or any one of the implementations of the fourth aspect, the interaction module is further configured to: after sending the customized mode enable signal to the hearing aid apparatus, receive an information display instruction sent by the hearing aid apparatus, where the information display instruction is sent by the hearing aid apparatus when detecting that the user is in a quiet environment; and display prompt information, where the prompt information is used to guide the user to make a sound.

According to the fourth aspect or any one of the implementations of the fourth aspect, the interaction module is further configured to: before displaying the prompt information, receive a first completion instruction sent by the hearing aid apparatus, where the first completion instruction is sent by the hearing aid apparatus when detecting that the user wears the hearing aid apparatus; and receive a second completion instruction sent by the hearing aid apparatus, where the second completion instruction is sent by the hearing aid apparatus when detecting that the user is in the quiet environment. The interaction module is further configured to: after displaying the prompt information, receive a third completion instruction sent by the hearing aid apparatus, where the third completion instruction is sent by the hearing aid apparatus when the hearing aid apparatus obtains the target signal; and output at least one piece of the following information: information indicating that detection is completed and information indicating that a customized parameter is generated.

The fourth aspect and any implementation of the fourth aspect respectively correspond to the second aspect and any implementation of the second aspect. For technical effects corresponding to the fourth aspect and any implementation of the fourth aspect, refer to the technical effects corresponding to the second aspect and any implementation of the second aspect. Details are not described herein again.

According to a fifth aspect, an embodiment of this application provides an electronic device, including: a processor and a transceiver; and a memory, configured to store one or more programs. When the one or more programs are executed by the one or more processors, the one or more processors are enabled to implement the method according to the first aspect and the second aspect or any one of the possible implementations of the first aspect and the second aspect.

The fifth aspect and any one of the implementations of the fifth aspect respectively correspond to the first aspect and the second aspect or any one of the possible implementations of the first aspect and the second aspect. For technical effects corresponding to the fifth aspect and any one of the implementations of the fifth aspect, refer to technical effects corresponding to the first aspect and the second aspect or any one of the possible implementations of the first aspect and the second aspect. Details are not described herein again.

According to a sixth aspect, an embodiment of this application provides a computer-readable storage medium, including a computer program. When the computer program runs on an electronic device, the electronic device is enabled to perform the method according to the first aspect and the second aspect or any one of the possible implementations of the first aspect and the second aspect.

The sixth aspect and any one of the implementations of the sixth aspect respectively correspond to the first aspect and the second aspect or any one of the possible implementations of the first aspect and the second aspect. For technical effects corresponding to the sixth aspect and any one of the implementations of the sixth aspect, refer to technical effects corresponding to the first aspect and the second aspect or any one of the possible implementations of the first aspect and the second aspect. Details are not described herein again.

According to a seventh aspect, an embodiment of this application provides a chip, including one or more interface circuits and one or more processors. The interface circuit is configured to: receive a signal from a memory of an electronic device, and send the signal to the processor, where the signal includes computer instructions stored in the memory. When the processor executes the computer instructions, the electronic device is enabled to perform the method according to the first aspect and the second aspect or any one of the possible implementations of the first aspect and the second aspect.

The seventh aspect and any one of the implementations of the seventh aspect respectively correspond to the first aspect and the second aspect or any one of the possible implementations of the first aspect and the second aspect. For technical effects corresponding to the seventh aspect and any one of the implementations of the seventh aspect, refer to technical effects corresponding to the first aspect and the second aspect or any one of the possible implementations of the first aspect and the second aspect. Details are not described herein again.

### BRIEF DESCRIPTION OF DRAWINGS

FIG. 1 is an example flowchart of a signal processing method;

FIG. 2 is an example diagram of a signal processing process;

FIG. 3 is an example diagram of a structure of a headset according to an embodiment of this application;

FIG. 4 is an example diagram of a structure of a signal processing system according to an embodiment of this application;

FIG. 5 is an example diagram of a structure of an electronic device 500 according to an embodiment of this application;

FIG. 6 is an example block diagram of a software structure of an electronic device 500 according to an embodiment of this application;

FIG. 7 is an example flowchart of a signal processing method according to an embodiment of this application;

FIG. 8 is an example diagram of a parameter adjustment interface according to an embodiment of this application;

FIG. 9 is an example diagram of a headset algorithm architecture according to an embodiment of this application;

FIG. 10 is another example diagram of a parameter adjustment interface according to an embodiment of this application;

FIG. 11 is another example diagram of a headset algorithm architecture according to an embodiment of this application;

FIG. 12a is an example diagram of a mode selection interface according to an embodiment of this application;

FIG. 12b is another example diagram of a mode selection interface according to an embodiment of this application;

FIG. 13 is another example diagram of a parameter adjustment interface according to an embodiment of this application;

FIG. 14 is an example diagram of a detection information display interface according to an embodiment of this application;

FIG. 15 is another example diagram of a structure of a headset according to an embodiment of this application;

FIG. 16 is another example diagram of a headset algorithm architecture according to an embodiment of this application;

FIG. 17 is another example flowchart of a signal processing method according to an embodiment of this application;

FIG. 18 is another example diagram of a mode selection interface according to an embodiment of this application;

FIG. 19 is another example diagram of a headset algorithm architecture according to an embodiment of this application;

FIG. 20 is a block diagram of an apparatus 2000 according to an embodiment of this application;

FIG. 21 is a block diagram of a hearing aid apparatus 2100 according to an embodiment of this application; and

FIG. 22 is a block diagram of a device control apparatus 2200 according to an embodiment of this application.

### DESCRIPTION OF EMBODIMENTS

The following clearly and completely describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application without creative efforts shall fall within the protection scope of this application.

The term “and/or” in this specification describes only an association relationship for associated objects and represents that three relationships may exist. For example, A and/or B may represent the following three cases: Only A exists, both A and B exist, and only B exists.

In the specification and claims in embodiments of this application, the terms “first”, “second”, and so on are intended to distinguish between different objects but do not indicate a particular order of the objects. For example, a first target object, a second target object, and the like are used for distinguishing between different target objects, but are not used for describing a specific order of the target objects.

In embodiments of this application, the term “example” or “for example” is used to represent giving an example, an illustration, or a description. Any embodiment or design scheme described as “example” or “for example” in embodiments of this application should not be construed as being more preferred or having more advantages than another embodiment or design scheme. Exactly, use of the term such as “example” or “for example” is intended to present a related concept in a specific manner.

In the descriptions of embodiments of this application, unless otherwise specified, “a plurality of” means two or more than two. For example, a plurality of processing units mean two or more processing units, and a plurality of systems mean two or more systems.

When a user wears a hearing aid apparatus, the hearing aid apparatus usually collects and plays a sound signal of a speech of the user, to ensure interaction with an external environment by the user, for example, a conversation between the user and another person. In this case, a problem that a self-speaking sound heard by the user through the hearing aid apparatus is dull and loud exists. Therefore, voice quality is not natural enough, and user experience is reduced. In view of this, in a related technology, processing such as phase inversion and amplitude adjustment may be performed on a signal collected by the hearing aid apparatus, to alleviate the problem that the sound is dull and loud.

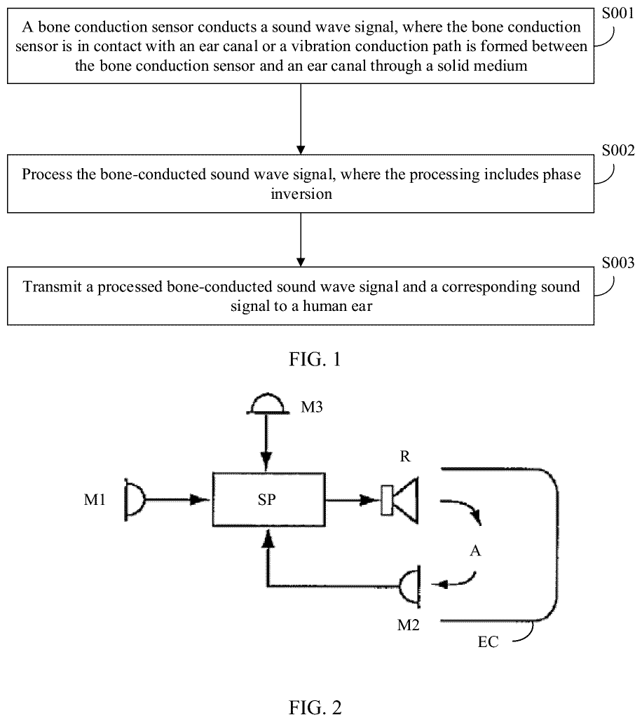

For example, FIG. 1 is an example flowchart of a signal processing method. As shown in FIG. 1, a procedure may include the following steps.

S001: A bone conduction sensor conducts a sound wave signal, where the bone conduction sensor is in contact with an ear canal or a vibration conduction path is formed between the bone conduction sensor and an ear canal through a solid medium.

S002: Process the bone-conducted sound wave signal, where the processing includes phase inversion.

S003: Transmit a processed bone-conducted sound wave signal and a corresponding sound signal to a human ear.

In the embodiment in FIG. 1, a phase of the bone-conducted sound wave signal is adjusted in S001 and S002, and then an adjusted signal and the corresponding sound signal are simultaneously played in the human ear in S003. The corresponding sound signal is a sound signal that is of a speech of a user and that is collected by a hearing aid apparatus. In this way, the played adjusted signal may cancel out the played sound signal, so that a problem that a sound heard by the user is dull and loud is relieved.

However, when the sound signal collected by the hearing aid apparatus includes an ambient sound of an environment in which the user is located, the played adjusted signal is no longer a phase-inverted signal of the played sound signal, the played sound signal cannot be canceled out, and the problem that the sound heard by the user is dull and loud cannot be resolved.

For example, FIG. 2 is an example diagram of a signal processing process. As shown in FIG. 2, a microphone M1 of a hearing aid apparatus collects an external environment signal, and a bone conduction sensor M3 collects a sound signal of a speech of a user. The external environment signal and the sound signal of the speech of the user are processed by an inverse feedback path SP and then played to an ear A of the user through a speaker R, that is, an in-ear signal of the user is generated. The in-ear signal of the user includes some external environment signals, a signal played by the speaker R, and the sound signal of the user. A microphone M2 of the hearing aid apparatus collects the in-ear signal of the user at an ear canal EC of the user, and sends the in-ear signal to the inverse feedback path SP for processing and playing. In this way, after adjusting a phase and an amplitude of the in-ear signal of the user, the inverse feedback path SP plays the signal simultaneously with the external environment signal collected by the microphone M1. A signal included in the adjusted in-ear signal of the user is the same as a signal included in the played external environment signal, and the external environment signal may be canceled out.

However, the external environment signal includes the sound signal of the speech of the user and the external environment sound. In the example in FIG. 2, not only the sound signal of the speech of the user is suppressed, but also the external environment sound is canceled out. As a result, the user cannot perceive the external environment sound.

An embodiment of this application provides a signal processing method, to resolve the foregoing problem. In this embodiment of this application, a first signal includes a self-speaking voice of a user and an ambient sound, and the second signal includes a sound signal of the user. In this way, the sound signal of the user in the first signal may be processed pertinently based on the first signal and the second signal, so that a problem that an ambient sound signal is canceled out when phase and amplitude cancellation is performed on the sound signal of the user in the first signal and the ambient sound signal in an undifferentiated manner is avoided. Therefore, in this embodiment of this application, the sound signal of the user can be processed without affecting the ambient sound signal, so that a problem that the sound is dell, loud, and not full enough when the user wears a hearing aid apparatus is reduced, and that the self-speaking sound that is of the user and that is heard by the user is more natural and the user may perceive the ambient sound is implemented.

Before the technical solutions in this embodiment of this application are described, an application scenario in this embodiment of this application is first described with reference to the accompanying drawings.

In this embodiment of this application, the hearing aid apparatus may include a headset or a hearing aid. The headset or the hearing aid has a digital augmented hearing (Digital Augmented Hearing) function, to perform signal processing. The headset is used as an example. The headset may include two sound production units, and the two sound production units each are connected to an edge of an ear. A sound production unit adapted to a left ear may be referred to as a left earphone, and a sound production unit adapted to a right ear may be referred to as a right earphone. From a perspective of a wearing manner, the headset in this embodiment of this application may be an over-ear headset, an ear-mounted headset, a neckband headset, an earplug headset, or the like. The earplug headset may specifically include an in-ear headset (or referred to as an ear canal headset) or a semi-in-ear headset. In an example, the in-ear headset is used as an example. A structure used for the left earphone is similar to that used for the right earphone. An earphone structure described below may be used for both the left earphone and the right earphone. The earphone structure (the left earphone or the right earphone) includes a rubber sleeve that can be inserted into an ear canal, an earbag close to an ear, and an earphone rod hung on the earbag. The rubber sleeve directs a sound to the ear canal. Components such as a battery, a speaker, and a sensor are included in the earbag. A microphone, a physical button, and the like can be deployed on the earphone rod. The earphone rod may be of a shape of a cylinder, a cuboid, an ellipse, or the like.

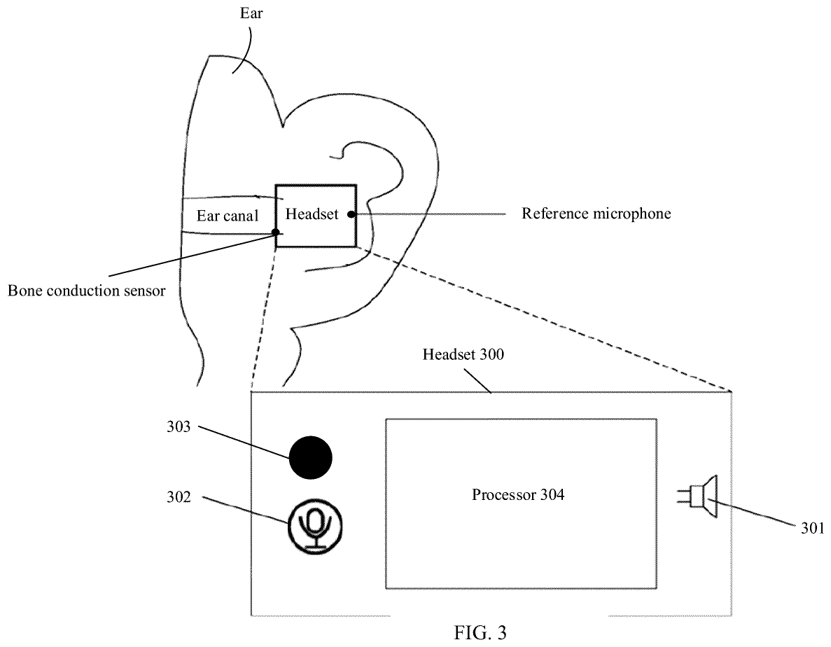

For example, FIG. 3 is an example diagram of a structure of a headset according to an embodiment of this application. As shown in FIG. 3, a headset 300 is worn on an ear of a user. The headset 300 may include a speaker 301, a reference microphone 302, a bone conduction sensor 303, and a processor 304. The reference microphone 302 is arranged on an outer side of the headset, and is configured to collect a sound signal outside the headset when the user wears the headset, where the sound signal may include a sound signal of a speech of the user and an ambient sound. The reference microphone 302 may be an analog microphone or a digital microphone. After the user wears the headset, a location relationship between the reference microphone 302 and the speaker 301 is as follows: The speaker 301 is located between an ear canal and the reference microphone 302, and is configured to play a processed sound collected by the microphone. In one case, the speaker may be further configured to play music. The reference microphone 302 is close to an external structure of the ear, and may be arranged on an upper part of an earphone rod. There is an earphone opening near the reference microphone 302, and the earphone opening is used to transmit the external ambient sound to the reference microphone 302. The bone conduction sensor 303 is arranged at a location that is inside the headset and that is attached to the ear canal. In other words, the bone conduction sensor 303 is attached to the ear canal, to collect a sound signal that is conducted through a human body and that is of the speech of the user. The processor 304 is configured to control the headset to collect and play a signal, and process the signal according to a processing algorithm.

It should be understood that the headset 300 includes a left earphone and a right earphone, and the left earphone and the right earphone may simultaneously implement a same signal processing function or different signal processing functions. When the left earphone and the right earphone simultaneously implement a same signal processing function, hearing perception of a left ear on which the user wears the left earphone and hearing perception of a right ear on which the user wears the right earphone may be the same.

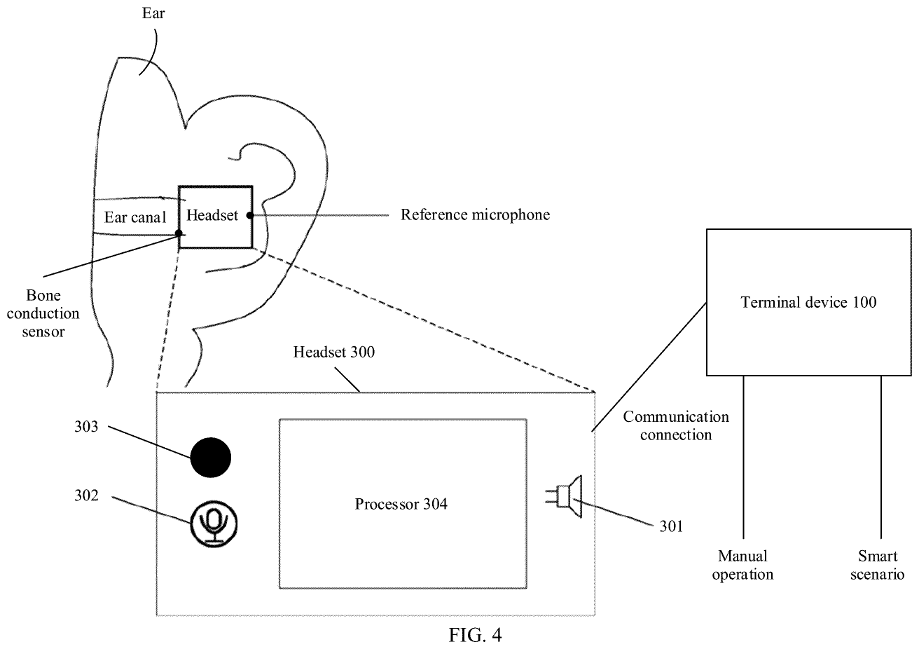

FIG. 4 is an example diagram of a structure of a signal processing system according to an embodiment of this application. As shown in FIG. 4, in some examples, an embodiment of this application provides a signal processing system. The signal processing system includes a terminal device 100 and a headset 300. The terminal device 100 is in a communication connection to the headset 300, and the connection may be a wireless connection or a wired connection. For a wireless connection, for example, the terminal device 100 may be connected to the headset 300 through a Bluetooth technology, a wireless fidelity (Wi-Fi) technology, an infrared (IR) technology, or an ultra-wideband technology.

In this embodiment of this application, the terminal device 100 is a device having an interface display function. The terminal device 100 may be, for example, an electronic device having a display interface, like a mobile phone, a display, a tablet computer, a vehicle-mounted device, or a smart television, or may be an electronic device such as an intelligent display wearable product, like a smart watch or a smart band. A specific form of the terminal device 100 is not specially limited in this embodiment of this application.

It should be understood that, in this embodiment of this application, the terminal device 100 may interact with the headset 300 through a manual operation, or may be used in a smart scenario to interact with the headset 300.

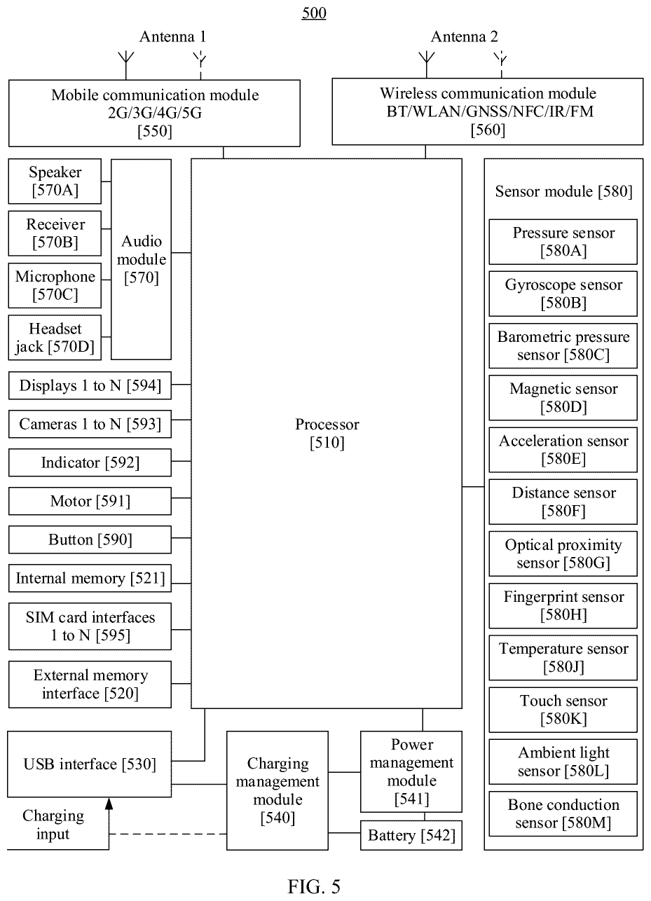

FIG. 5 is an example diagram of a structure of an electronic device 500 according to an embodiment of this application. As shown in FIG. 5, the electronic device 500 may be any one of the terminal device and the headset included in the signal processing system shown in FIG. 4.

It should be understood that the electronic device 500 shown in FIG. 5 is merely an example, and the electronic device 500 may have more or fewer components than those shown in the figure, or may combine two or more components, or may have different component configurations. The components shown in FIG. 5 may be implemented in hardware, software, or a combination of hardware and software including one or more signal processing and/or application-specific integrated circuits.

The electronic device 500 may include: a processor 510, an external memory interface 520, an internal memory 521, a universal serial bus (USB) interface 530, a charging management module 540, a power management module 541, a battery 542, an antenna 1, an antenna 2, a mobile communication module 550, a wireless communication module 560, an audio module 570, a speaker 570A, a receiver 570B, a microphone 570C, a headset jack 570D, a sensor module 580, a button 590, and a motor 591, an indicator 592, a camera 593, a display 594, a subscriber identity module (SIM) card interface 595, and the like. The sensor module 580 may include a pressure sensor 580A, a gyroscope sensor 580B, a barometric pressure sensor 580C, a magnetic sensor 580D, an acceleration sensor 580E, a distance sensor 580F, an optical proximity sensor 580G, a fingerprint sensor 580H, a temperature sensor 580J, a touch sensor 580K, an ambient light sensor 580L, a bone conduction sensor 580M, and the like.

The processor 510 may include one or more processing units. For example, the processor 510 may include an application processor (AP), a modem processor, a graphics processing unit (GPU), an image signal processor (ISP), a controller, a memory, a video codec, a digital signal processor (DSP), a baseband processor, and/or a neural-network processing unit (NPU). Different processing units may be independent components, or may be integrated into one or more processors.

The controller may be a nerve center and a command center of the electronic device 500. The controller may generate an operation control signal based on instruction operation code and a time sequence signal, to complete control of instruction fetching and instruction execution.

A memory may be further disposed in the processor 510, and is configured to store instructions and data. In some embodiments, the memory in the processor 510 is a cache. The memory may store instructions or data that has been recently used or cyclically used by the processor 510. If the processor 510 needs to use the instructions or the data again, the processor 510 may directly invoke the instructions or the data from the memory. This avoids repeated access, reduces a waiting time of the processor 510, and improves system efficiency.

In some embodiments, the processor 510 may include one or more interfaces. The interfaces may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus, and includes one serial data line (SDA) and one serial clock line (SCL). In some embodiments, the processor 510 may include a plurality of groups of I2C buses. The processor 510 may be separately coupled to the touch sensor 580K, a charger, a flash, the camera 593, and the like through different I2C bus interfaces. For example, the processor 510 may be coupled to the touch sensor 580K through the I2C interface, so that the processor 510 communicates with the touch sensor 580K through the I2C bus interface, to implement a touch function of the electronic device 500.

The I2S interface may be configured to perform audio communication. In some embodiments, the processor 510 may include a plurality of groups of I2S buses. The processor 510 may be coupled to the audio module 570 through the I2S bus, to implement communication between the processor 510 and the audio module 570. In some embodiments, the audio module 570 may transmit an audio signal to the wireless communication module 560 through the I2S interface, to implement a function of answering a call through a Bluetooth headset.

The PCM interface may also be used to perform audio communication, and sample, quantize, and code an analog signal. In some embodiments, the audio module 570 may be coupled to the wireless communication module 560 through a PCM bus interface. In some embodiments, the audio module 570 may alternatively transmit an audio signal to the wireless communication module 560 through the PCM interface, to implement a function of answering a call through a Bluetooth headset. Both the I2S interface and the PCM interface may be configured to perform audio communication.

The UART interface is a universal serial data bus, and is configured to perform asynchronous communication. The bus may be a two-way communication bus. The bus converts to-be-transmitted data between serial communication and parallel communication. In some embodiments, the UART interface is usually configured to connect the processor 510 to the wireless communication module 560. For example, the processor 510 communicates with a Bluetooth module in the wireless communication module 560 through the UART interface, to implement a Bluetooth function. In some embodiments, the audio module 570 may transmit an audio signal to the wireless communication module 560 through the UART interface, to implement a function of playing music through a Bluetooth headset.

The MIPI interface may be configured to connect the processor 510 to a peripheral component such as the display 594 or the camera 593. The MIPI interface includes a camera serial interface (CSI), a display serial interface (DSI), and the like. In some embodiments, the processor 510 communicates with the camera 593 through the CSI, to implement a photographing function of the electronic device 500. The processor 510 communicates with the display 594 through the DSI, to implement a display function of the electronic device 500.

The GPIO interface may be configured by software. The GPIO interface may be configured as a control signal or a data signal. In some embodiments, the GPIO interface may be configured to connect the processor 510 to the camera 593, the display 594, the wireless communication module 560, the audio module 570, the sensor module 580, and the like. The GPIO interface may alternatively be configured as an I2C interface, an I2S interface, a UART interface, an MIPI interface, or the like.

The USB interface 530 is an interface that conforms to a USB standard specification, and may be specifically a mini USB interface, a micro USB interface, a USB Type-C interface, or the like. The USB interface 530 may be configured to connect to a charger to charge the electronic device 500, or may be configured to transmit data between the electronic device 500 and a peripheral device, or may be configured to connect to a headset for playing audio through the headset. The interface may be further configured to connect to another electronic device such as an AR device.

It may be understood that an interface connection relationship between the modules illustrated in embodiments of this application is merely an example for description, and does not constitute a limitation on the structure of the electronic device 500. In some other embodiments of this application, the electronic device 500 may alternatively use an interface connection manner different from that in the foregoing embodiment, or use a combination of a plurality of interface connection manners.

The charging management module 540 is configured to receive a charging input from a charger. The charger may be a wireless charger or a wired charger. In some embodiments of wired charging, the charging management module 540 may receive a charging input of a wired charger through the USB interface 530. In some embodiments of wireless charging, the charging management module 540 may receive a wireless charging input through a wireless charging coil of the electronic device 500. The charging management module 540 supplies power to the electronic device through the power management module 541 while charging the battery 542.

The power management module 541 is configured to connect the battery 542, the charging management module 540, and the processor 510. The power management module 541 receives an input from the battery 542 and/or the charging management module 540, and supplies power to the processor 510, the internal memory 521, an external memory, the display 594, the camera 593, the wireless communication module 560, and the like. The power management module 541 may be further configured to monitor a parameter such as a battery capacity, a battery cycle count, or a battery health status (electric leakage or impedance). In some other embodiments, the power management module 541 may alternatively be disposed in the processor 510. In some other embodiments, the power management module 541 and the charging management module 540 may alternatively be disposed in a same device.

A wireless communication function of the electronic device 500 may be implemented by using the antenna 1, the antenna 2, the mobile communication module 550, the wireless communication module 560, the modem processor, the baseband processor, and the like.

The antenna 1 and the antenna 2 are configured to transmit and receive electromagnetic wave signals. Each antenna in the electronic device 500 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 550 may provide a wireless communication solution that is applied to the electronic device 500 and that includes 2G/3G/4G/5G. The mobile communication module 550 may include at least one filter, a switch, a power amplifier, a low noise amplifier (LNA), and the like. The mobile communication module 550 may receive an electromagnetic wave through the antenna 1, perform processing such as filtering or amplification on the received electromagnetic wave, and transmit the electromagnetic wave to the modem processor for demodulation. The mobile communication module 550 may further amplify a signal modulated by the modem processor, and convert the signal into an electromagnetic wave for radiation through the antenna 1. In some embodiments, at least some function modules in the mobile communication module 550 may be disposed in the processor 510. In some embodiments, at least some function modules in the mobile communication module 550 may be disposed in a same device as at least some modules of the processor 510.

The modem processor may include a modulator and a demodulator. The modulator is configured to modulate a to-be-transmitted low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (not limited to the speaker 570A, the receiver 570B, and the like), and displays an image or a video through the display 594. In some embodiments, the modem processor may be an independent component. In some other embodiments, the modem processor may be independent of the processor 510, and is disposed in a same device as the mobile communication module 550 or another function module.

The wireless communication module 560 may provide a wireless communication solution that is applied to the electronic device 500 and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 560 may be one or more components integrating at least one communication processing module. The wireless communication module 560 receives an electromagnetic wave through the antenna 2, performs frequency modulation and filtering processing on an electromagnetic wave signal, and sends a processed signal to the processor 510. The wireless communication module 560 may further receive a to-be-transmitted signal from the processor 510, perform frequency modulation and amplification on the signal, and convert the signal into an electromagnetic wave for radiation through the antenna 2.

In some embodiments, the antenna 1 and the mobile communication module 550 in the electronic device 500 are coupled, and the antenna 2 and the wireless communication module 560 in the electronic device 500 are coupled, so that the electronic device 500 can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The electronic device 500 may implement a display function through the GPU, the display 594, the application processor, and the like. The GPU is a microprocessor for image processing, and is connected to the display 594 and the application processor. The GPU is configured to perform mathematical and geometric computation, and render an image. The processor 510 may include one or more GPUs, and the one or more GPUs execute program instructions to generate or change display information.

The display 594 is configured to display an image, a video, and the like. The display 594 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device 500 may include one or N displays 594, where N is a positive integer greater than 1.

The electronic device 500 may implement a photographing function through the ISP, the camera 593, the video codec, the GPU, the display 594, the application processor, and the like.

The ISP is configured to process data fed back by the camera 593. For example, during shooting, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 593.

The camera 593 is configured to capture a static image or a video. An optical image of an object is generated through a lens, and is projected onto the photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 500 may include one or N cameras 593, where N is a positive integer greater than 1.

The digital signal processor is configured to process a digital signal, and may process another digital signal in addition to the digital image signal. For example, when the electronic device 500 selects a frequency, the digital signal processor is configured to perform Fourier transformation on frequency energy.

The video codec is configured to compress or decompress a digital video. The electronic device 500 may support one or more video codecs. Therefore, the electronic device 500 may play or record videos in a plurality of encoding formats, for example, moving picture experts group (MPEG)-1, MPEG-2, MPEG-3, and MPEG-4.

The NPU is a neural-network (NN) computing processor. The NPU quickly processes input information by referring to a structure of a biological neural network, for example, a transfer mode between human brain neurons, and may further continuously perform self-learning. Applications such as intelligent cognition of the electronic device 500 may be implemented through the NPU, for example, image recognition, facial recognition, voice recognition, and text understanding.

The external memory interface 520 may be used to connect to an external memory card, for example, a micro SD card, to extend a storage capability of the electronic device 500. The external memory card communicates with the processor 510 through the external memory interface 520, to implement a data storage function. For example, files such as music and videos are stored in the external memory card.

The internal memory 521 may be configured to store computer-executable program code. The executable program code includes instructions. The processor 510 runs the instructions stored in the internal memory 521, to perform various function applications of the electronic device 500 and data processing. The internal memory 521 may include a program storage area and a data storage area. The program storage area may store an operating system, an application required by at least one function (for example, a voice playing function or an image playing function), and the like. The data storage area may store data (for example, audio data or an address book) and the like created when the electronic device 500 is used. In addition, the internal memory 521 may include a high-speed random access memory, or may include a nonvolatile memory, for example, at least one magnetic disk storage device, a flash memory, or a universal flash storage (UFS).

The electronic device 500 may implement an audio function such as music playing or recording through the audio module 570, the speaker 570A, the receiver 570B, the microphone 570C, the headset jack 570D, the application processor, and the like.

The audio module 570 is configured to convert digital audio information into an analog audio signal for output, and is also configured to convert analog audio input into a digital audio signal. The audio module 570 may be further configured to encode and decode an audio signal. In some embodiments, the audio module 570 may be disposed in the processor 510, or some function modules in the audio module 570 are disposed in the processor 510.

The speaker 570A, also referred to as a “loudspeaker”, is configured to convert an audio electrical signal into a sound signal. The electronic device 500 may be used to listen to music or answer a call in a hands-free mode over the speaker 570A.

The receiver 570B, also referred to as an “earpiece”, is configured to convert an electrical audio signal into a sound signal. When a call is answered or a voice message is received through the electronic device 500, the receiver 570B may be put close to a human ear to listen to a voice.

The microphone 570C, also referred to as a “mike” or a “mic”, is configured to convert a sound signal into an electrical signal. When making a call or sending a voice message, a user may make a sound near the microphone 570C through the mouth of the user, to input a sound signal to the microphone 570C. At least one microphone 570C may be disposed in the electronic device 500. In some other embodiments, two microphones 570C may be disposed in the electronic device 500, to collect a sound signal and implement a noise reduction function. In some other embodiments, three, four, or more microphones 570C may alternatively be disposed in the electronic device 500, to collect a sound signal, implement noise reduction, and identify a sound source, to implement a directional recording function and the like.

The headset jack 570D is configured to connect to a wired headset. The headset jack 570D may be the USB interface 530, or may be a 3.5 mm open mobile terminal platform (OMTP) standard interface, or a cellular telecommunications industry association of the USA (CTIA) standard interface.

The pressure sensor 580A is configured to sense a pressure signal, and can convert the pressure signal into an electrical signal. In some embodiments, the pressure sensor 580A may be disposed on the display 594. There are a plurality of types of pressure sensors 580A, such as a resistive pressure sensor, an inductive pressure sensor, and a capacitive pressure sensor. The capacitive pressure sensor may include at least two parallel plates made of conductive materials. When a force is applied to the pressure sensor 580A, capacitance between electrodes changes. The electronic device 500 determines pressure intensity based on the change of the capacitance. When a touch operation is performed on the display 594, the electronic device 500 detects intensity of the touch operation through the pressure sensor 580A. The electronic device 500 may also calculate a touch location based on a detection signal of the pressure sensor 580A. In some embodiments, touch operations that are performed in a same touch location but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating a new SMS message is performed.

The gyroscope sensor 580B may be configured to determine a moving posture of the electronic device 500. In some embodiments, an angular velocity of the electronic device 500 around three axes (that is, axes x, y, and z) may be determined through the gyro sensor 580B. The gyroscope sensor 580B may be configured to implement image stabilization during photographing. For example, when the shutter is pressed, the gyroscope sensor 580B detects an angle at which the electronic device 500 jitters, calculates, based on the angle, a distance for which a lens module needs to compensate, and allows the lens to cancel the jitter of the electronic device 500 through reverse motion, to implement image stabilization. The gyroscope sensor 580B may also be used in a navigation scenario or a somatic game scenario.

The barometric pressure sensor 580C is configured to measure barometric pressure. In some embodiments, the electronic device 500 calculates an altitude through the barometric pressure measured by the barometric pressure sensor 580C, to assist in positioning and navigation.

The magnetic sensor 580D includes a Hall sensor. The electronic device 500 may detect opening and closing of a flip cover by using the magnetic sensor 580D. In some embodiments, when the electronic device 500 is a clamshell phone, the electronic device 500 may detect opening and closing of a flip cover based on the magnetic sensor 580D. Further, a feature such as automatic unlocking upon opening of the flip cover is set based on a detected opening or closing state of the flip cover.

The acceleration sensor 580E may detect magnitude of acceleration of the electronic device 500 in various directions (usually on three axes). A magnitude and a direction of gravity may be detected when the electronic device 500 is still. The acceleration sensor 580E may be further configured to identify a posture of the electronic device, and is used in an application such as switching between a landscape mode and a portrait mode or a pedometer.

The distance sensor 580F is configured to measure a distance. The electronic device 500 may measure the distance in an infrared manner or a laser manner. In some embodiments, in a photographing scenario, the electronic device 500 may measure a distance by using the distance sensor 580F to implement quick focusing.

The optical proximity sensor 580G may include, for example, a light-emitting diode (LED) and an optical detector, for example, a photodiode. The light-emitting diode may be an infrared light-emitting diode. The electronic device 500 emits infrared light by using the light emitting diode. The electronic device 500 detects infrared reflected light from a nearby object by using the photodiode. When sufficient reflected light is detected, it may be determined that there is an object near the electronic device 500. When insufficient reflected light is detected, the electronic device 500 may determine that there is no object near the electronic device 500. The electronic device 500 may detect, by using the optical proximity sensor 580G, that the user holds the electronic device 500 close to an ear for a call, to automatically turn off a screen for power saving. The optical proximity sensor 580G may also be used in a smart cover mode or a pocket mode to automatically perform screen unlocking or locking.

An ambient optical sensor 580L is configured to sense ambient light brightness. The electronic device 500 may adaptively adjust brightness of the display 594 based on the sensed ambient light brightness. The ambient light sensor 580L may also be configured to automatically adjust white balance during photographing. The ambient light sensor 580L may also cooperate with the optical proximity sensor 580G to detect whether the electronic device 500 is in a pocket, to avoid an accidental touch.

The fingerprint sensor 580H is configured to collect a fingerprint. The electronic device 500 may use a feature of the collected fingerprint to implement fingerprint-based unlocking, application lock access, fingerprint-based photographing, fingerprint-based call answering, and the like.

The temperature sensor 580J is configured to detect a temperature. In some embodiments, the electronic device 500 executes a temperature processing policy based on the temperature detected by the temperature sensor 580J. For example, when the temperature reported by the temperature sensor 580J exceeds a threshold, the electronic device 500 lowers performance of a processor nearby the temperature sensor 580J, to reduce power consumption for thermal protection. In some other embodiments, when the temperature is lower than another threshold, the electronic device 500 heats the battery 542 to prevent the electronic device 500 from being shut down abnormally due to a low temperature. In some other embodiments, when the temperature is lower than still another threshold, the electronic device 500 boosts an output voltage of the battery 542 to avoid abnormal shutdown caused by a low temperature.

The touch sensor 580K is also referred to as a “touch panel”. The touch sensor 580K may be disposed on the display 594, and the touch sensor 580K and the display 594 form a touchscreen, which is also referred to as a “touch screen”. The touch sensor 580K is configured to detect a touch operation performed on or near the touch sensor. The touch sensor may transfer the detected touch operation to the application processor to determine a type of a touch event. A visual output related to the touch operation may be provided through the display 594. In some other embodiments, the touch sensor 580K may alternatively be disposed on a surface of the electronic device 500 at a location different from that of the display 594.

The bone conduction sensor 580M may obtain a vibration signal. In some embodiments, the bone conduction sensor 580M may obtain a vibration signal of a vibration bone of a human vocal-cord part. The bone conduction sensor 580M may also be in contact with a human pulse, to receive a blood pressure beating signal. In some embodiments, the bone conduction sensor 580M may also be disposed in a headset, to obtain a bone conduction headset. The audio module 570 may obtain a voice signal through parsing based on the vibration signal that is of the vibration bone of the vocal-cord part and that is obtained by the bone conduction sensor 580M, to implement a voice function. The application processor may parse heart rate information based on the blood pressure beating signal obtained by the bone conduction sensor 580M, to implement a heart rate detection function.

The button 590 includes a power button, a volume button, and the like. The button 590 may be a mechanical button, or may be a touch button. The electronic device 500 may receive a button input, and generate a button signal input related to user settings and function control of the electronic device 500.

The motor 591 may generate a vibration prompt. The motor 591 may be configured to provide an incoming call vibration prompt and a touch vibration feedback. For example, touch operations performed on different applications (for example, photographing and audio playing) may correspond to different vibration feedback effects. The motor 591 may also correspond to different vibration feedback effects for touch operations performed on different areas of the display 594. Different application scenarios (for example, a time reminder, information receiving, an alarm clock, and a game) may also correspond to different vibration feedback effects. A touch vibration feedback effect may be further customized.

The indicator 592 may be an indicator light, and may be configured to indicate a charging status and a power change, or may be configured to indicate a message, a missed call, a notification, and the like.

The SIM card interface 595 is configured to connect to a SIM card. The SIM card may be inserted into the SIM card interface 595 or removed from the SIM card interface 595, to implement contact with or separation from the electronic device 500. The electronic device 500 may support one or N SIM card interfaces, where N is a positive integer greater than 1. The SIM card interface 595 may support a nano-SIM card, a micro-SIM card, a SIM card, and the like. A plurality of cards may be inserted into a same SIM card interface 595 at the same time. The plurality of cards may be of a same type or different types. The SIM card interface 595 is also compatible with different types of SIM cards. The SIM card interface 595 is also compatible with an external memory card. The electronic device 500 interacts with a network by using the SIM card, to implement functions such as conversation and data communication. In some embodiments, the electronic device 500 uses an eSIM, that is, an embedded SIM card. The eSIM card may be embedded into the electronic device 500, and cannot be separated from the electronic device 500.

A software system of the electronic device 500 may use a layered architecture, an event-driven architecture, a microkernel architecture, a micro service architecture, or a cloud architecture. In embodiments of this application, an Android system with a layered architecture is used as an example to describe a software structure of the electronic device 500.

A software system of the electronic device 500 may use a layered architecture, an event-driven architecture, a microkernel architecture, a micro service architecture, or a cloud architecture. In embodiments of this application, an Android system with a layered architecture is used as an example to describe a software structure of the electronic device 500.

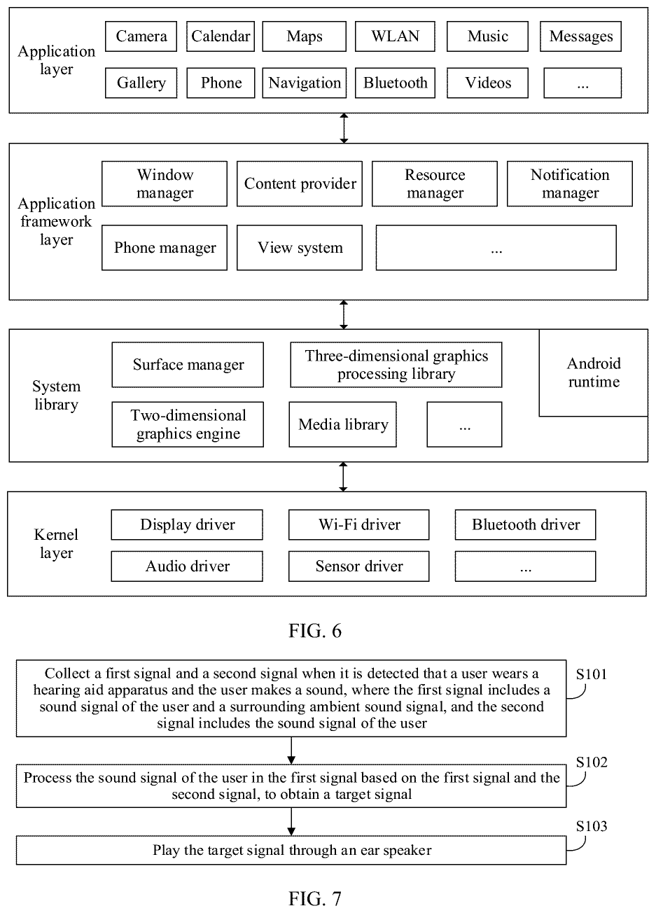

FIG. 6 is an example block diagram of a software structure of an electronic device 500 according to an embodiment of this application.

In a layered architecture of the electronic device 500, software is divided into several layers, and each layer has a clear role and task. The layers communicate with each other through a software interface. In some embodiments, the Android system is divided into four layers: an application layer, an application framework layer, an Android runtime (Android runtime) and a system library, and a kernel layer.

The application layer may include a series of application packages.

As shown in FIG. 6, the application packages may include applications such as Camera, Gallery, Calendar, Phone, Maps, Navigation, WLAN, Bluetooth, Music, Videos, and Messages.

The application framework layer provides an application programming interface (API) and a programming framework for an application at the application layer. The application framework layer includes some predefined functions.

As shown in FIG. 6, the application framework layer may include a window manager, a phone manager, a content provider, a view system, a resource manager, a notification manager, and the like.

The window manager is configured to manage a window program. The window manager may obtain a size of the display, determine whether there is a status bar, perform screen locking, take a screenshot, and the like.

The phone manager is configured to provide a communication function of the electronic device 500, for example, management of a call status (including answering, declining, or the like).

The content provider is configured to store and obtain data, and enable the data to be accessed by an application. The data may include a video, an image, audio, calls that are made and received, a browsing history, a bookmark, a phone book, and the like.

The view system includes visual controls such as a control for displaying a text and a control for displaying an image. The view system may be configured to construct an application. A display interface may include one or more views. For example, a display interface including a messages notification icon may include a text display view and an image display view.

The resource manager provides various resources such as a localized character string, an icon, an image, a layout file, and a video file for an application.

The notification manager enables an application to display notification information in a status bar, and may be configured to convey a notification message. The notification manager may automatically disappear after a short pause without a user interaction. For example, the notification manager is configured to notify download completion, give a message notification, and the like. The notification manager may alternatively be a notification that appears in a top status bar of the system in a form of a graph or a scroll bar text, for example, a notification of an application that is run on a background, or may be a notification that appears on the screen in a form of a dialog window. For example, text information is displayed in the status bar, an alert sound is played, the electronic device vibrates, or the indicator light blinks.

The Android runtime includes a kernel library and a virtual machine. The Android runtime is responsible for scheduling and management of the Android system.

The kernel library includes two parts: a performance function that needs to be invoked in java language, and a kernel library of Android.

The application layer and the application framework layer run on the virtual machine.

The virtual machine executes java files of the application layer and the application framework layer as binary files. The virtual machine is configured to implement functions such as object lifecycle management, stack management, thread management, security and exception management, and garbage collection.

The system library may include a plurality of function modules, for example, a surface manager (surface manager), a two-dimensional graphics engine (for example, SGL), a three-dimensional graphics processing library (for example, OpenGL ES), and a media library (Media Library).

The surface manager is configured to manage a display subsystem and provide fusion of 2D and 3D layers for a plurality of applications.

The 2D graphics engine is a drawing engine for 2D drawing.

The three-dimensional graphics processing library is configured to implement three-dimensional graphics drawing, image rendering, composition, layer processing, and the like.

The media library supports playing and recording of a plurality of commonly used audio and video formats, static image files, and the like. The media library may support a plurality of audio and video encoding formats, for example, MPEG4, H.264, MP3, AAC, AMR, JPG, and PNG.

The kernel layer is a layer between hardware and software. The kernel layer includes at least a display driver, an audio driver, a Wi-Fi driver, a sensor driver, and a Bluetooth driver.

It should be understood that components included in the software structure shown in FIG. 6 do not constitute a specific limitation on the electronic device 500. In some other embodiments of this application, the electronic device 500 may include more or fewer components than those shown in the figure, combine some components, split some components, or have different component arrangements.

In this application, a hearing aid apparatus may be configured to collect a first signal that includes a self-speaking voice of a user and an ambient sound, and a second signal that includes a sound signal of the user, to pertinently process the sound signal of the user in the first signal based on the first signal and the second signal, and implement that the self-speaking sound that is of the user and that is heard by the user is more natural and the user may perceive the ambient sound.

FIG. 7 is an example flowchart of a signal processing method according to an embodiment of this application. As shown in FIG. 7, the signal processing method is applied to a hearing aid apparatus, and may specifically include but is not limited to the following steps.

S101: Collect a first signal and a second signal when it is detected that a user wears the hearing aid apparatus and the user makes a sound, where the first signal includes a sound signal of the user and a surrounding ambient sound signal, and the second signal includes the sound signal of the user.

When detecting that the user wears the hearing aid apparatus and the user makes the sound, the hearing aid apparatus may collect the first signal and the second signal, to ensure successful collection and appropriate signal processing of the first signal and the second signal. For example, as shown in FIG. 3, the hearing aid apparatus may collect the first signal via the reference microphone 302, and collect the second signal via the bone conduction sensor 303. The surrounding ambient sound signal may include a sound signal other than a sound of a speech of the user in a physical environment in which the user is located. For example, the surrounding ambient sound signal may include at least one of the following signals: a sound signal of a person who talks with the user face to face, a music signal in the physical environment in which the user is located, a conversation sound, a vehicle horn sound, and the like. The bone conduction sensor 303 collects a sound signal conducted through a human bone, to ensure that the collected sound signal is a sound signal of the speech of the user wearing the hearing aid apparatus, that is, a self-speaking signal of the user.

In an optional implementation, the hearing aid apparatus may detect, via a first sensor, whether the user wears the hearing aid apparatus. If the user wears the hearing aid apparatus, the hearing aid apparatus detects, via a second sensor, whether the user makes the sound. If detecting that the user makes the sound, the hearing aid apparatus collects the first signal and the second signal. The first sensor may include a pressure sensor, a temperature sensor, and the like. The second sensor may be the bone conduction sensor 303.

S102: Process the sound signal of the user in the first signal based on the first signal and the second signal, to obtain a target signal.

After collecting the first signal and the second signal, the hearing aid apparatus may process the sound signal of the user in the first signal based on the first signal and the second signal, to obtain the target signal. A manner in which the hearing aid apparatus processes the sound signal of the user in the first signal may include attenuation processing or enhancement processing. The attenuation processing is used to resolve a problem that hearing perception of the sound signal of the user in the first signal is dull, and the enhancement processing is used to resolve a problem that hearing perception of the sound signal of the user in the first signal is not full. Therefore, an effect that the sound signal of the user heard by the user via the hearing aid apparatus is more natural can be implemented.

For the attenuation processing, in an optional implementation, that the hearing aid apparatus processes the sound signal of the user in the first signal based on the first signal and the second signal, to obtain the target signal may specifically include but is not limited to the following steps:
filtering the first signal based on the second signal, to obtain a filtering gain; and
performing attenuation processing on the sound signal of the user in the first signal based on the filtering gain, to obtain the target signal.

When the sound signal of the user in the first signal is processed, the sound signal of the user in the first signal may be considered as a noise signal. Correspondingly, the hearing aid apparatus may filter the first signal based on the second signal, to obtain the filtering gain, where the filtering gain is a signal-to-noise ratio between the surrounding ambient sound signal and the sound signal of the user that are in the first signal. In an optional implementation, a specific manner in which the hearing aid apparatus filters the first signal based on the second signal, to obtain the filtering gain may include the following steps:
filtering the sound signal of the user in the first signal based on the second signal, to obtain an expected signal; and
calculating a ratio of the expected signal to the first signal, to obtain the filtering gain.

For example, the first signal and the second signal may be input to an adaptive filter, to obtain the expected signal output by the adaptive filter. For example, the first signal is A, and the second signal is B. The adaptive filter may apply a filter coefficient h to the signal A to obtain h*A. Based on this, the adaptive filter adaptively predicts and updates the filter coefficient h until an expected signal C is obtained, for example, obtains the expected signal that does not include the second signal B. In this way, the filtering gain G may be obtained by calculating a ratio of the expected signal C to the first signal A: G=C/A. The adaptive filter may be, for example, a filter like a Kalman filter or a Wiener filter. Kalman filtering (Kalman filtering) is an algorithm that uses a linear system state equation to perform optimal estimation, that is, filtering, on a system state of a filter based on input and output observation data of the filter. An essence of the Wiener filter (Wiener filter) is to minimize a mean square value of an estimation error (defined as a difference between an expected response and an actual output of the filter).

In this embodiment, the filtering gain is obtained based on the expected signal, and the expected signal is a signal that meets an expectation of attenuation processing on the second signal in the first signal, so that accuracy of the filtering gain can be ensured. Based on this, attenuation processing performed based on the filtering gain may be more accurate.

In an optional implementation, a specific manner in which the hearing aid apparatus filters the first signal based on the second signal, to obtain the filtering gain may include the following step: inputting the first signal and the second signal into a signal adjustment model obtained through pre-training, to obtain the filtering gain output by the signal adjustment model. The signal adjustment model is obtained by performing unsupervised training based on a sample first signal and a sample second signal.

In an example, that the hearing aid apparatus performs attenuation processing on the sound signal of the user in the first signal based on the filtering gain, to obtain the target signal may specifically include: The hearing aid apparatus applies the filtering gain to the first signal, to implement attenuation processing on the sound signal of the user in the first signal, so as to obtain the target signal. For example, the gain G is multiplied by the first signal A, to obtain the target signal A*G in which the second signal B in the first signal A is attenuated.

In an optional implementation, that the hearing aid apparatus filters the first signal based on the second signal, to obtain a filtering gain may specifically include the following steps:
filtering the first signal based on the second signal, to obtain an original filtering gain;
obtaining at least one of a degree correction amount and a frequency band range; and
adjusting a magnitude of the original filtering gain based on the degree correction amount, to obtain the filtering gain; and/or
adjusting, based on the frequency band range, a frequency band on which the original filtering gain is enabled, to obtain the filtering gain.

It may be understood that a manner in which the hearing aid apparatus filters the first signal based on the second signal, to obtain the original filtering gain may be adjusting a model based on an adaptive filter or based on a signal obtained through pre-training. For details, refer to the foregoing related descriptions. Details are not described herein again.

It should be noted that, for the two steps of obtaining at least one of the degree correction amount and the frequency band range and filtering the first signal based on the second signal to obtain the original filtering gain, the hearing aid apparatus may perform the two steps sequentially or simultaneously. An order of performing the two steps is not limited in embodiments of this application.

For example, the degree correction amount is used to adjust an attenuation degree of the second signal in the first signal. The frequency band range is used to limit attenuation processing to be performed on the second signal that is in the first signal and that belongs to the frequency band range. After obtaining at least one of the degree correction amount and the frequency band range, the hearing aid apparatus may perform at least one of the following steps: The hearing aid apparatus adjusts a magnitude of the original filtering gain based on the degree correction amount, to obtain the filtering gain, or adjusts, based on the frequency band range, a frequency band on which the original filtering gain is enabled, to obtain the filtering gain. For example, a manner in which the hearing aid apparatus adjusts the magnitude of the original filtering gain based on the degree correction amount may include: The hearing aid apparatus calculates a sum value or a product of the degree correction amount and the original filtering gain.

It may be understood that a manner of calculating the sum value is applicable to a case in which the degree correction amount is an increment or a decrement. For example, the filtering gain G=the original filtering gain G0+the degree correction amount Z. When Z is an increment, a symbol of Z is positive, that is, “+”. When Z is a decrement, a symbol of Z is negative, that is, “−”. A manner of calculating the product is applicable to a case in which the degree correction amount is a proportional coefficient. For example, the filtering gain G=the original filtering gain G0*the degree correction amount Z, where Z may be, for example, 0.7, 1, or 80%. A specific degree correction amount may be set based on an application requirement. This is not limited in this application.

For example, a manner in which the hearing aid apparatus adjusts, based on the frequency band range, the frequency band on which the original filtering gain is enabled, to obtain the filtering gain may specifically include: The hearing aid apparatus separately selects, from a plurality of original filtering gains corresponding to different frequency bands, an original filtering gain whose corresponding frequency band belongs to the frequency band range, to obtain the filtering gain. For example, the original filtering gain G0=the expected signal C/the first signal A. Both the expected signal C and the first signal A include a plurality of signals of different frequency bands, and original filtering gains G0 corresponding to different frequency bands are obtained separately. In this way, when adjusting, based on the frequency band range, the frequency band on which the original filtering gain is enabled, the hearing aid apparatus only needs to select the original filtering gain whose corresponding frequency band belongs to the frequency band range. In an optional case, when calculating the original filtering gain, the hearing aid apparatus may calculate a ratio of the expected signal C that belongs to the frequency band range to the first signal A, to obtain the filtering gain. It may be understood that, in this case, the hearing aid apparatus first obtains the frequency band range, and then filters the first signal based on the second signal and the frequency band range, to obtain the filtering gain.

In an optional implementation, that the hearing aid apparatus obtains at least one of a degree correction amount and a frequency band range may specifically include the following steps:
establishing a communication connection to a target terminal, where the target terminal is configured to display a parameter adjustment interface, and the parameter adjustment interface includes at least one of the following setting controls: an adjustment degree setting control and a frequency band range setting control; and
receiving at least one of the degree correction amount and the frequency band range that are sent by the target terminal, where the degree correction amount and the frequency band range are obtained by the target terminal by detecting an operation on the adjustment degree setting control and an operation on the frequency band range setting control.

As shown in FIG. 3, the target terminal may be the terminal device 100. For a manner of establishing the communication connection between the hearing aid apparatus and the terminal device 100, refer to the descriptions of the embodiment in FIG. 3. Details are not described herein again. In an example, the user may enable Bluetooth of a mobile phone and Bluetooth of a headset for pairing, to establish a communication connection between the mobile phone and the headset. Based on this, the user may control the headset in a device management application of the mobile phone.

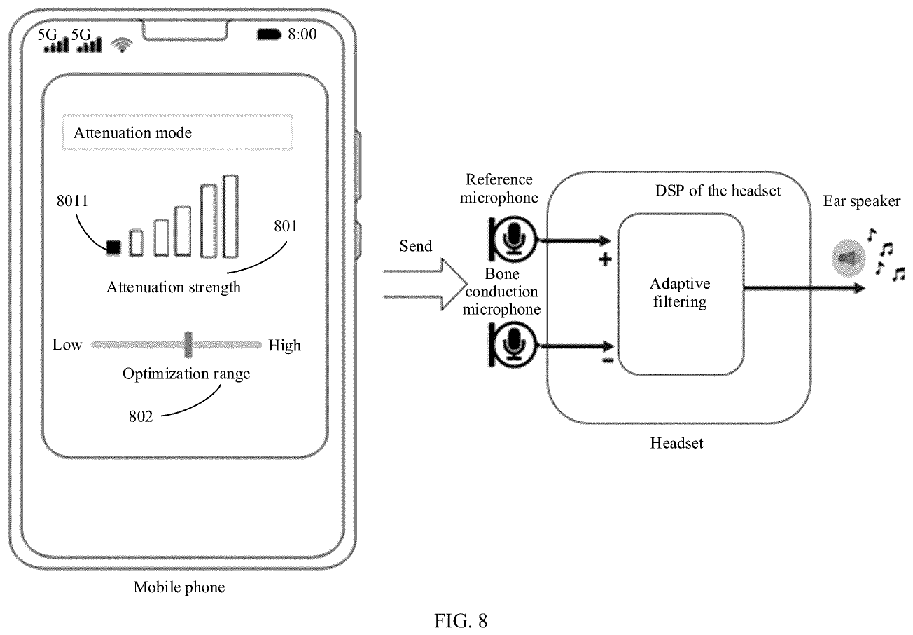

The mobile phone and the headset are used as examples. FIG. 8 is an example diagram of a parameter adjustment interface according to an embodiment of this application. As shown in FIG. 8, after the mobile phone establishes the communication connection to the headset, the user may tap a headset management control in the device management application. When detecting the tap operation, the mobile phone displays a UI (User Interface), for example, a parameter adjustment interface. At least one of an adjustment degree setting control 801 and a frequency band range setting control 802 is arranged on the parameter adjustment interface. In this case, the mobile phone detects an operation on the adjustment degree setting control 801 and an operation on the frequency band range setting control 802, to obtain at least one of a degree correction amount and a frequency band range. In an optional implementation, as shown in FIG. 8, the adjustment degree setting control 801 may include six rectangles with different heights. Each of the six rectangles indicates a correction amount, and a larger correction amount indicates a higher height of the rectangle. In other words, suppression of the sound signal of the user in the first signal is controlled by six rectangles, that is, six levels of strength, on the UI of the mobile phone, and suppression strength is enhanced by dragging the rectangle from left to right. The frequency band range setting control 802 includes a frequency band range icon (such as an optimization range bar) and a slider located on the frequency band range icon. For example, the frequency band range icon is a rectangle, space description information “optimization range” is set with the rectangle, and prompt information “low” and “high” is set separately at endpoints of the rectangle. That is, the optimization range bar may be dragged leftward or rightward. When the optimization range bar is dragged from left to right, a bandwidth range of the suppressed sound signal of the user in the first signal becomes larger. In this way, the user may perform, on the slider based on the prompt information, a sliding operation that meets a requirement of the user for adjusting the frequency band range. The parameter adjustment interface in this embodiment is used to set attenuation strength and an attenuation frequency band range for attenuation processing. Correspondingly, control description information “attenuation information” may be set on the adjustment degree setting control 801.

Based on the parameter adjustment interface in the embodiment in FIG. 8, that the mobile phone detects an operation on the adjustment degree setting control and an operation on the frequency band range setting control, to obtain at least one of a degree correction amount and a frequency band range may specifically include the following steps:
detecting a tap operation on the plurality of rectangles on the adjustment degree setting control; and
determining, as the degree correction amount, a correction amount indicated by the rectangle on which the tap operation is detected; and/or
detecting a sliding operation on the slider on the frequency band range setting control; and
determining the frequency band range based on a sliding location of the slider.

As shown in FIG. 8, rectangles with different heights may indicate different correction amounts. Correspondingly, a correction amount indicated by each rectangle may be prestored in the mobile phone, so that when detecting a rectangle tapped by the user, the mobile phone may determine the correction amount indicated by the rectangle as the degree correction amount. In a case, when detecting a tap operation performed by the user on a rectangle, the mobile phone may display the tapped rectangle in a specified color different from that of another rectangle in the plurality of rectangles. For example, as shown in FIG. 8, if the mobile phone detects that the user taps a rectangle 8011, the mobile phone displays the rectangle in black. Black is different from a color, for example, white, of another rectangle on the adjustment degree setting control 801.

Still as shown in FIG. 8, sliders at different locations may correspond to different frequency band ranges. Correspondingly, the mobile phone may prestore frequency band ranges corresponding to different locations of the slider on the frequency band range setting control, so that when detecting a location of the slider, the mobile phone can determine a frequency band range corresponding to the location as the frequency band range sent to the headset.

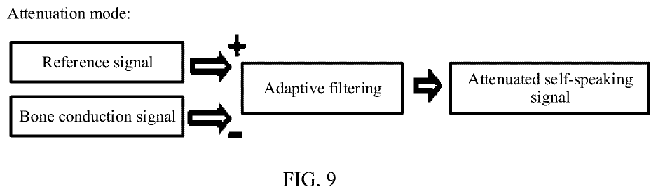

After obtaining the at least one of the degree correction amount and the frequency band range, the mobile phone may send the at least one of the degree correction amount and the frequency band range to the headset. As shown in FIG. 8, a reference microphone is the reference microphone, and a bone conduction microphone is the bone conduction sensor. For example, FIG. 9 is an example diagram of a headset algorithm architecture according to an embodiment of this application. As shown in FIG. 9, attenuation processing may be considered as signal processing performed by the headset in an attenuation mode. With reference to FIG. 9, in FIG. 8, a processing symbol of a reference signal collected by the reference microphone is “+”, and a processing symbol of a bone conduction signal collected by the bone conduction microphone is “−”. The attenuation processing means that the headset may filter the sound signal of the user in the first signal through adaptive filtering of a DSP (like the processor 304 in FIG. 3) of the headset based on the reference signal, that is, the first signal, and the bone conduction signal, that is, the second signal, to obtain the original filtering gain. In this way, the headset may adjust, via the DSP of the headset, the original filtering gain based on at least one of the degree correction amount and the frequency band range that are received from the mobile phone, and further process the sound signal of the user in the first signal based on an adjustment result, to obtain the target signal, that is, an attenuated self-speaking signal. Based on this, an ear speaker of the headset may play the target signal.

In this embodiment of this application, a user may set, through a UI, at least one of an attenuation degree of attenuation processing and a frequency band range of an attenuated sound signal, to obtain an attenuation effect that meets a user requirement, that is, a self-speaking suppression effect, so that user experience can be further improved.

For the enhancement processing, in an optional implementation, that the hearing aid apparatus processes the sound signal of the user in the first signal based on the first signal and the second signal, to obtain a target signal may specifically include the following steps:
enhancing the first signal based on the second signal, to obtain a compensated signal; and
performing enhancement processing on the sound signal of the user in the first signal based on the compensated signal, to obtain the target signal.

The hearing aid apparatus enhances the first signal based on the second signal, to obtain the compensated signal. In this way, the compensated signal may be used to perform enhancement processing on the sound signal of the user in the first signal, to improve fullness of the sound signal of the user in the first signal. As a result, a problem that the sound signal of the user in the target signal heard by the user through the ear speaker is not full enough can be resolved. In an optional implementation, that the hearing aid apparatus enhances the first signal based on the second signal, to obtain a compensated signal may include the following steps:
determining a weighting coefficient of the second signal;
obtaining an enhanced signal based on the weighting coefficient and the second signal; and
loading the enhanced signal to the first signal, to obtain the compensated signal.

For example, a manner in which the hearing aid apparatus determines the weighting coefficient of the second signal may include: The hearing aid apparatus reads the weighting coefficient of the second signal prestored in the hearing aid apparatus. Alternatively, in an optional implementation, that the hearing aid apparatus determines a weighting coefficient of the second signal may include the following step: The hearing aid apparatus obtains a degree correction amount, and obtains the weighting coefficient of the second signal based on the degree correction amount. For example, the hearing aid apparatus may read the degree correction amount prestored in the hearing aid apparatus, or receive the degree correction amount sent by the mobile phone communicatively connected to the hearing aid apparatus, and further determine the degree correction amount as the weighting coefficient of the second signal, or calculate a sum value/product of the degree correction amount and the original weighting coefficient. A specific application case of the sum value and the product is similar to an application case of the sum value and the product in the foregoing attenuation processing, and a difference lies in that the original weighting coefficient is calculated. For a same part, details are not described herein again. For details, refer to the descriptions of the application case of the sum value and the product in the foregoing attenuation processing.

That the hearing aid apparatus obtains an enhanced signal based on the weighting coefficient and the second signal may be specifically: calculating a product of the weighting coefficient and the second signal, to obtain the enhanced signal. For example, if the second signal is B and the weighting coefficient is 50%, the enhanced signal is B*50%. That the hearing aid apparatus loads the enhanced signal to the first signal, to obtain the compensated signal may specifically include: The hearing aid apparatus calculates a sum of the enhanced signal and the first signal, to obtain the compensated signal. For example, if the first signal is A, the compensated signal C=(A+B*50%). It should be noted that, in an optional implementation, that the hearing aid apparatus enhances the first signal based on the second signal, to obtain a compensated signal may include the following steps:
obtaining at least one of a degree correction amount and a frequency band range; and
enhancing the first signal based on signal compensation strength indicated by the degree correction amount and the second signal, to obtain the compensated signal; and/or
enhancing, based on the second signal, the first signal belonging to the frequency band range, to obtain the compensated signal.

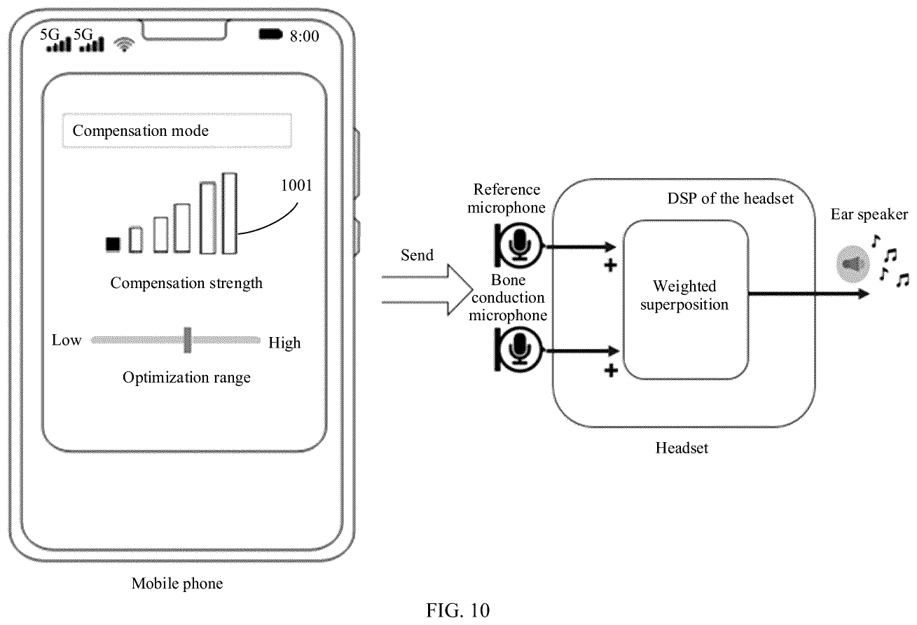

A specific manner in which the hearing aid apparatus obtains at least one of the degree correction amount and the frequency band range is similar to a manner in which the hearing aid apparatus obtains at least one of the degree correction amount and the frequency band range for attenuation processing, and a difference lies in that the hearing aid apparatus obtains at least one of the degree correction amount and the frequency band range for enhancement processing herein. Based on this, in a scenario for obtaining via the mobile phone, the adjustment degree setting control in the parameter adjustment interface of the mobile phone may be adaptively adjusted. For same content, details are not described herein again. For details, refer to the descriptions of the embodiment in FIG. 8. For example, FIG. 10 is another example diagram of a parameter adjustment interface according to an embodiment of this application. As shown in FIG. 10, in a scenario of enhancement processing, the adjustment degree setting control may be six rectangles 1001 that indicate compensation strength. Each rectangle 1001 indicates a degree correction amount, for example, may indicate a weighting coefficient. When the user performs an operation of dragging or tapping a rectangle on the parameter adjustment interface, the mobile phone detects the operation, to determine compensation strength indicated by the operated rectangle, and correspondingly obtain the weighting coefficient of the second signal. A higher height of a rectangle indicates a higher enhancement degree. In other words, when the rectangle is dragged from left to right, the weighting coefficient increases, so that an enhancement degree of the sound signal of the user in the first signal can be improved. In other words, a compensation effect for the self-speaking of the user is enhanced. For the optimization range bar, refer to the related descriptions of the embodiment in FIG. 8, and details are not described herein again.

It may be understood that, when the signal compensation strength indicated by the degree correction amount in the embodiment of FIG. 10 is the weighting coefficient of the second signal, that the hearing aid apparatus enhances the first signal based on signal compensation strength indicated by the degree correction amount and the second signal, to obtain the compensated signal may specifically include: determining the degree correction amount as the weighting coefficient of the second signal; obtaining the enhanced signal based on the weighting coefficient and the second signal; and loading the enhanced signal to the first signal, to obtain the compensated signal.

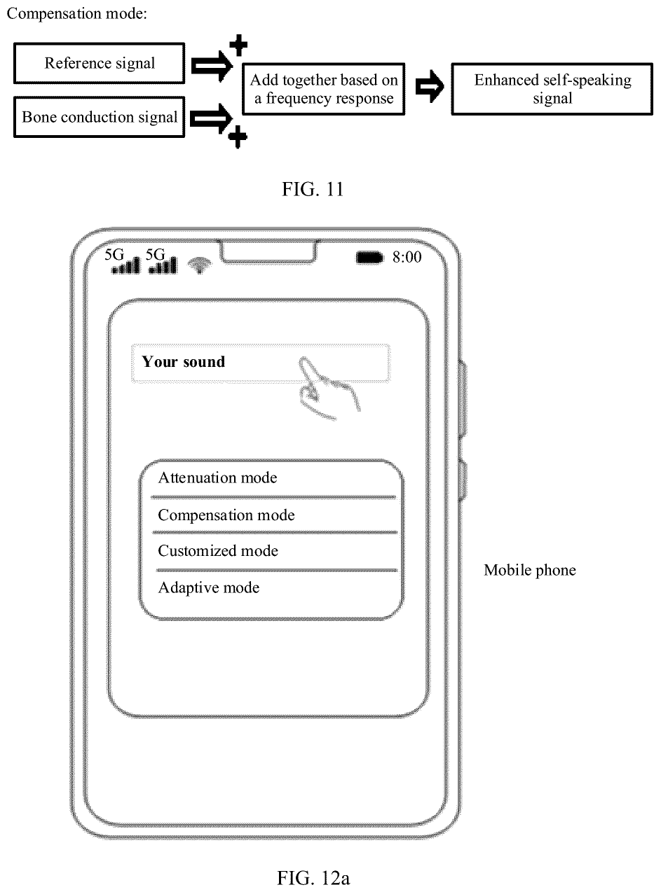

For example, FIG. 11 is another example diagram of a headset algorithm architecture according to an embodiment of this application. As shown in FIG. 11, enhancement processing may be considered as signal processing performed by the headset in an enhancement mode. With reference to FIG. 11, in FIG. 10, a processing symbol of a reference signal collected by the reference microphone is “+”, and a processing symbol of a bone guide signal collected by the bone conduction microphone is “+”. The headset may perform enhancement processing on the reference signal, that is, the first signal, through weighted superposition of a DSP (like the processor 304 in FIG. 3) of the headset based on the bone conduction signal, that is, the second signal, to obtain the target signal, that is, an enhanced self-speaking signal. In an example, the enhancement processing may include: separately performing Fourier transform on the first signal and the second signal, to obtain a frequency response of each frequency in the first signal and a frequency response of each frequency in the second signal, so as to weight the first signal and the second signal based on the frequency response, that is, the frequency response. For example, C1=A+B. It should be noted that the frequency response of each frequency may be obtained by performing Fourier transform. The frequency (Frequency) refers to a specific absolute frequency value, and is generally a center frequency of a modulated signal.

In this embodiment of this application, the user may set, through the UI, at least one of the enhancement degree of the enhancement processing and the frequency band range of the enhanced sound signal, to obtain an enhancement effect that meets a user requirement, that is, a self-speaking enhancement effect, so that user experience can be further improved.

In an optional implementation, the target terminal is further configured to display a mode selection interface, where the mode selection interface includes a self-speaking optimization mode selection control. Correspondingly, before collecting the first signal and the second signal, the hearing aid apparatus may further perform the following steps:
when a self-speaking optimization mode enable signal sent by the target terminal is received, detecting whether the user wears the hearing aid apparatus, where the self-speaking optimization mode enable signal is sent when the target terminal detects an enable operation on the self-speaking optimization mode selection control; and
if the user wears the hearing aid apparatus, detecting whether the user makes the sound.

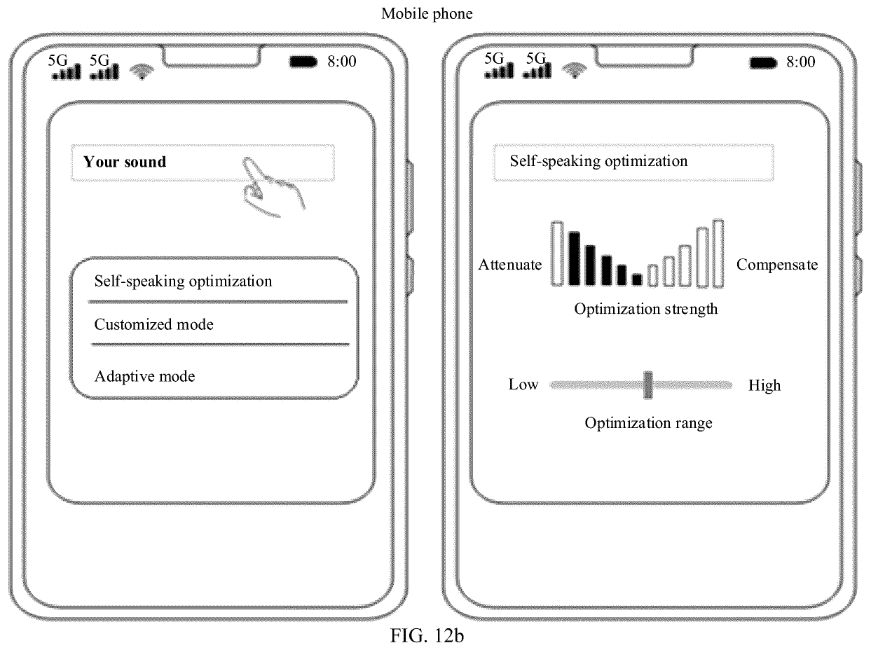

For example, FIG. 12a is an example diagram of a mode selection interface according to an embodiment of this application. As shown in FIG. 12a, a self-speaking optimization mode may include an attenuation mode and a compensation mode. The user selects a “your sound” function in the device management application of the mobile phone to manage the headset. In this case, the mobile phone may display at least one of an attenuation mode selection control and a compensation mode selection control. For example, the user may tap the attenuation mode selection control, to implement an enable operation on the attenuation mode, and the target terminal correspondingly sends an enable signal of the self-speaking optimization mode, for example, the attenuation mode. In this case, with reference to FIG. 9, the hearing aid apparatus may execute an algorithm in the attenuation mode. Enabling of the compensation mode is similar to that of the attenuation mode, and a difference lies in that enabled modes are different. Correspondingly, as shown in FIG. 11, the hearing aid apparatus executes an algorithm in the enhancement mode.

In an optional implementation, after displaying the mode selection interface, the target terminal may display the parameter adjustment interface when the enable operation performed by the user on the self-speaking optimization mode selection control is detected.

For example, as shown in FIG. 12a, when the user selects the attenuation mode, the mobile phone displays the parameter adjustment interface shown in FIG. 8. The parameter adjustment interface may include mode prompt information of the “attenuation mode”. Similarly, when the user selects the compensation mode, the mobile phone displays the parameter adjustment interface shown in FIG. 10. The parameter adjustment interface may include mode prompt information of the “compensation mode”.

For example, FIG. 12b is another example diagram of a mode selection interface according to an embodiment of this application. As shown in FIG. 12b, the self-speaking optimization mode selection control may not be distinguished as the attenuation mode selection control and the compensation mode selection control. Correspondingly, the mobile phone may display the parameter adjustment interface in the attenuation mode and the parameter adjustment interface in the compensation mode on one interface. In this way, the user taps the self-speaking optimization selection control, and when detecting the operation, the mobile phone may enable the self-speaking optimization mode, and further display the parameter adjustment interface in FIG. 12b. It may be understood that a rectangle in the attenuation control in FIG. 12b is the same as the rectangle in FIG. 8, and a rectangle in the compensation control in FIG. 12b is the same as the rectangle in FIG. 10. For details, refer to descriptions in the related embodiment. Details are not described herein again. It may be understood that a shortest rectangle in an optimization strength control in FIG. 12b may indicate that optimization strength is 0, that is, neither attenuation nor compensation is performed.

It should be noted that specific shapes of the controls are examples, and shapes of the controls may be disk shapes or the like. This is not limited in embodiments of this application. In a case, different modes may be set in a form of buttons. When the user taps a button, it indicates that a mode is enabled.

In an optional implementation, the parameter adjustment interface may include a left-ear adjustment interface and a right-ear adjustment interface.

Correspondingly, that the mobile phone detects an operation on the adjustment degree setting control and an operation on the frequency band range setting control, to obtain at least one of a degree correction amount and a frequency band range may specifically include the following steps:
detecting an operation on a setting control on the left-ear adjustment interface, to obtain left-ear correction data, where the left-ear correction data includes at least one of a left-ear degree correction amount and a left-ear frequency band range; and
detecting an operation on a setting control on the right-ear adjustment interface, to obtain right-ear correction data, where the right-ear correction data includes at least one of a right-ear degree correction amount and a right-ear frequency band range.

Correspondingly, that the hearing aid apparatus receives at least one of the degree correction amount and the frequency band range that are sent by the target terminal may specifically include the following steps:

The hearing aid apparatus may receive at least one of the left-ear correction data and the right-ear correction data that are sent by the target terminal (for example, the mobile phone), and select, based on an ear identifier carried in the left-ear correction data and/or the right-ear correction data, correction data corresponding to an ear that is the same as an ear in which the hearing aid apparatus is located.

In an optional implementation, the left earphone and the right earphone may separately establish a communication connection to the mobile phone. Correspondingly, the mobile phone may perform at least one of the following steps: The mobile phone sends the left-ear correction data to the left earphone through the communication connection to the left earphone; and the mobile phone sends the right-ear correction data to the right earphone through the communication connection to the right earphone. In this case, either of the left earphone and the right earphone may directly perform signal processing based on the received correction data, and does not need to screen the received correction data based on the ear identifier. This is more efficient and reduces calculation costs.

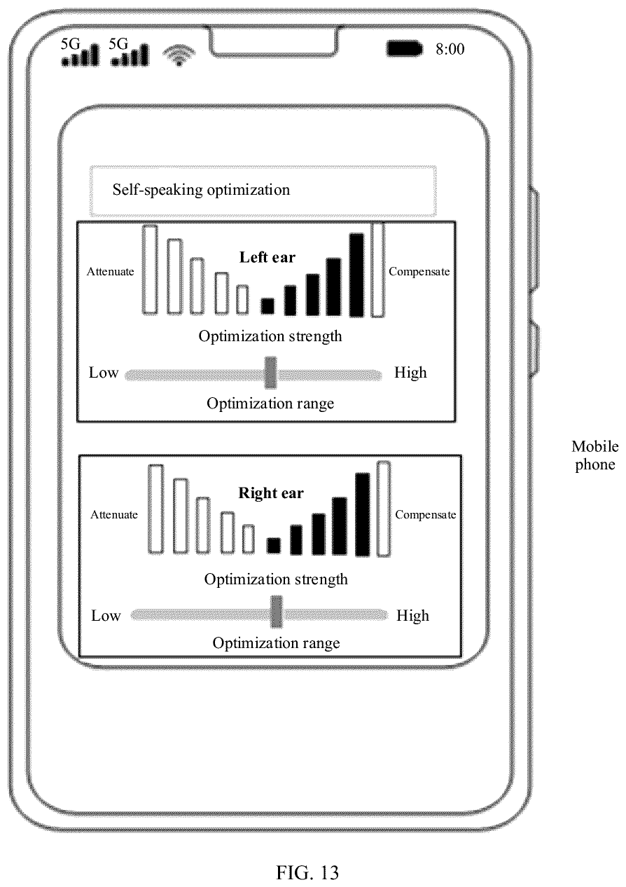

For example, FIG. 13 is another example diagram of a parameter adjustment interface according to an embodiment of this application. As shown in FIG. 13, the left-ear adjustment interface may be an interface on which ear identification information “left ear” is displayed on the interface of the mobile phone in FIG. 13, and the right-ear adjustment interface may be an interface on which ear identification information “right ear” is displayed on the interface of the mobile phone in FIG. 13. It may be understood that both the left-ear adjustment interface and the right-ear adjustment interface are similar to the parameter adjustment interface shown in FIG. 12b, and a difference lies in that different ear identification information is displayed to guide the user to separately set signal processing parameters for the left ear and the right ear on different interfaces. In other words, in the embodiment of FIG. 13, the left and right earphones are separately controlled through two UI interfaces, that is, an earphone of one ear is controlled through one interface. A control manner is the same as a control manner when two earphones are controlled through one interface. Refer to the control manners described in FIG. 8, FIG. 10, and FIG. 12a and FIG. 12b. In this way, the user may set different parameters for the two earphones of the left ear and the right ear, to match an ear difference or meet requirements of different applications, so that customization of signal processing is further improved and user experience is improved.

In an optional implementation, that the hearing aid apparatus enhances the first signal based on the second signal, to obtain the compensated signal may include the following steps: The hearing aid apparatus inputs the first signal and the second signal into a signal enhancement model obtained through pre-training, to obtain the compensated signal output by the signal enhancement model, where the signal enhancement model is obtained by performing unsupervised training based on a sample first signal and a sample second signal.

In some examples, that the hearing aid apparatus performs enhancement processing on the sound signal of the user in the first signal based on the compensated signal, to obtain the target signal may specifically include: updating a to-be-enhanced signal in the first signal based on an available compensated signal that belongs to a frequency band range and that is in the compensated signal, where the to-be-enhanced signal belongs to the frequency band range. For example, the frequency band range is from 0 kHz to 8 kHz. The compensated signal C and the first signal A each are transformed to a frequency domain through Fourier transform, to obtain a frequency domain C signal and a frequency domain A signal. A non-enhanced signal whose frequency band is greater than 8 kHz is determined in the frequency domain A signal, a signal whose frequency band is greater than 8 kHz in the frequency domain C signal is replaced with the non-enhanced signal, and available compensated signals of 0 kHz to 8 kHz in the frequency domain C signal are maintained, that is, are reserved in weighted compensation processing, to obtain a frequency domain target signal. Based on this, the frequency domain target signal is transformed to a time domain through inverse Fourier transform, that is, the target signal is obtained.

S103: Play the target signal through the ear speaker.

When obtaining the target signal in the manner of the foregoing embodiments, the hearing aid apparatus may play the target signal through the ear speaker. In this way, enhancement or attenuation processing is performed on the sound signal that is of the user in the first signal and that is heard by the user, and the sound signal may be more natural. The ear speaker may be, for example, 301 shown in FIG. 3.

In an optional implementation, that when detecting that a user wears the hearing aid apparatus and the user makes the sound, the hearing aid apparatus collects a first signal and a second signal may specifically include the following steps:
detecting, via a first sensor, whether the user wears the hearing aid apparatus;
detecting, via a third sensor, whether the user is in a quiet environment if the user wears the hearing aid apparatus;
detecting, via a second sensor, whether the user makes the sound if the user is in the quiet environment; and
collecting the first signal and the second signal if the user makes the sound.

For wearing detection and detection of the sound made by the user, refer to related descriptions of the embodiment in FIG. 7. Details are not described herein again. Detection of whether the user is in the quiet environment may be implemented via the third sensor, for example, a reference microphone.

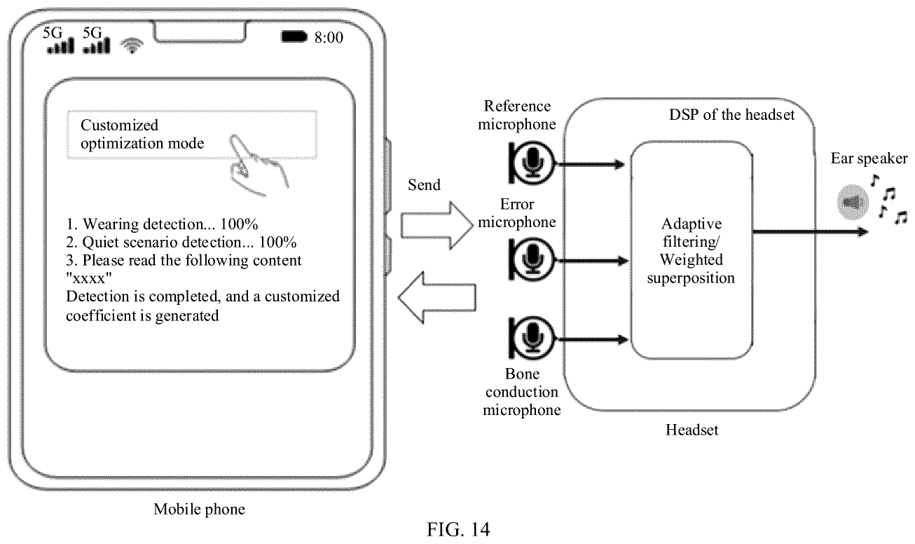

In an optional implementation, as shown in FIG. 12a or FIG. 12b, after displaying the mode selection interface, if detecting an enable operation on the customized mode selection control “customized optimization mode”, the mobile phone may send a customized mode enable signal to the headset. Further, when receiving the customized mode enable signal sent by the target terminal, the headset detects, via the first sensor, whether the user wears the hearing aid apparatus. For example, FIG. 14 is an example diagram of a detection information display interface according to an embodiment of this application. As shown in FIG. 14, when detecting the enable operation on the customized mode selection control, the mobile phone may display a detection information display interface in the customized optimization mode. The detection information display interface may display at least one of wearing detection progress information, quiet scenario detection progress information, and prompt information that guides the user to make a sound. For example, the wearing detection progress information is “1. Wearing detection . . . ”. When detecting that the user wears the hearing aid apparatus, the headset sends a first completion instruction to the mobile phone. When the mobile phone receives the first completion instruction, displayed progress information is information indicating that detection is completed, for example, “1. Wearing detection . . . 100%” in FIG. 14.

Still as shown in FIG. 14, when receiving the first completion instruction, the mobile phone displays the quiet scenario detection progress information, for example, “2. Quiet scenario detection . . . ”. When detecting that the user is in the quiet environment, the headset sends a second completion instruction to the mobile phone. When the mobile phone receives the second completion instruction, displayed progress information is information indicating that detection is completed, for example, “2. Quiet scenario detection . . . 100%” in FIG. 14. The second completion instruction may be considered as an information display instruction. When receiving the second completion instruction, the mobile phone may display the prompt information that guides the user to make a sound, for example, “3. Please read the following content “XXXX”” in FIG. 14. It may be understood that both the first completion instruction and the second completion instruction may be considered as a third completion instruction, so that when receiving the third completion instruction, the mobile phone may display information indicating that detection is completed, for example, “2. Quiet scenario detection . . . 100%”.

It should be noted that the mobile phone may display at least one of the information shown in FIG. 14, and the information may be specifically set based on an application requirement. This is not limited in embodiments of this application. According to the embodiment in FIG. 14, the user can intuitively learn a progress of customized setting performed by the mobile phone on the headset. The prompt information that guides the user to make a sound can improve efficiency of collecting the sound signal of the user, so that signal processing efficiency is improved.

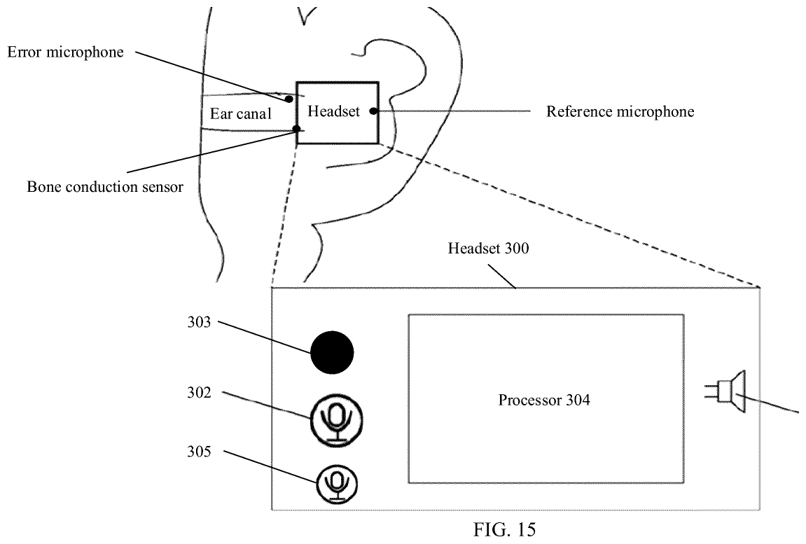

With reference to the embodiment in FIG. 14, FIG. 15 is another example diagram of a structure of a headset according to an embodiment of this application. As shown in FIG. 15, the headset 300 in the embodiments in FIG. 3 and FIG. 4 of this application may further include an error microphone 305. The error microphone 305 is arranged inside the headset and close to the ear canal. In this way, in an optional implementation, that the hearing aid apparatus processes the sound signal of the user in the first signal based on the first signal and the second signal, to obtain a target signal may specifically include the following steps:
collecting a third signal at the ear canal of the user;
playing the first signal and the third signal in the ear of the user;
collecting a fourth signal and a fifth signal, where the fourth signal includes a signal obtained by mapping the first signal by the ear canal, and the fifth signal includes a signal obtained by mapping the third signal by the ear canal;
determining a frequency response difference between the fourth signal and the fifth signal; and
processing the sound signal of the user in the first signal based on the first signal, the second signal, and the frequency response difference, to obtain the target signal, where the frequency response difference indicates a degree of processing.

For example, as shown in FIG. 14, the headset may collect the third signal at the ear canal of the user through the error microphone, that is, the error microphone 305, where the third signal is a signal at the ear canal of the user. For example, the fourth signal may approximately be a sound signal D of the user that is heard by the user when the user does not wear the headset and that is obtained by mapping an external signal collected by the reference microphone by the ear canal. The fifth signal may be, for example, a sound signal E that is at a tympanic membrane of the ear and that is obtained by mapping the signal collected by the error microphone by the ear canal. In an optional implementation, that the hearing aid apparatus determines a frequency response difference between the fourth signal and the fifth signal may specifically include the following steps:
obtaining a frequency response of the fourth signal and a frequency response of the fifth signal; and
calculating a difference value between the frequency response of the fourth signal and the frequency response of the fifth signal, to obtain the frequency response difference.

In an optional implementation, that the hearing aid apparatus processes the sound signal of the user in the first signal based on the first signal, the second signal, and the frequency response difference, to obtain the target signal may specifically include the following steps:
determining, based on the frequency response difference, that a processing type is attenuation or enhancement; and
when the processing type is attenuation, performing attenuation processing on the sound signal of the user in the first signal based on the frequency response difference, to obtain the target signal; or when the processing type is enhancement, performing enhancement processing on the sound signal of the user in the first signal based on the frequency response difference, to obtain the target signal.

For example, as shown in FIG. 14, the headset performs the following algorithm step via the DSP of the headset: comparing a frequency response difference between the signal B and the signal A, to obtain a compensation amount or an attenuation amount for the sound signal of the user in the first signal, that is, the self-speaking signal. For example, the headset separately performs Fourier transform on the sound signal D and the sound signal E, to obtain a frequency response of each frequency, and subtracts the frequency response of the sound signal D from the frequency response of the sound signal E, to obtain the frequency response difference. The frequency response difference is, for example, a compensation amount (for example, a weighting coefficient) or an attenuation amount (for example, a filtering gain), and may indicate a degree of processing. After obtaining the compensation amount or the attenuation amount, the headset may send the third signal to the mobile phone, so that the mobile phone may display information indicating that a customized coefficient is generated, for example, “Detection is completed, and the customized coefficient is generated” in FIG. 14.

It may be understood that the headset may determine, based on a positive or negative frequency response difference, whether to perform compensation or attenuation. For example, when the sound signal D−the sound signal E=the frequency response difference, if the frequency response difference is positive, the headset may determine that the processing type is attenuation, or if the frequency response difference is negative, the headset may determine that the processing type is enhancement. When the sound signal E−the sound signal D=the frequency response difference, if the frequency response difference is positive, the headset may determine that the processing type is enhancement, or if the frequency response difference is negative, the headset may determine that the processing type is attenuation.

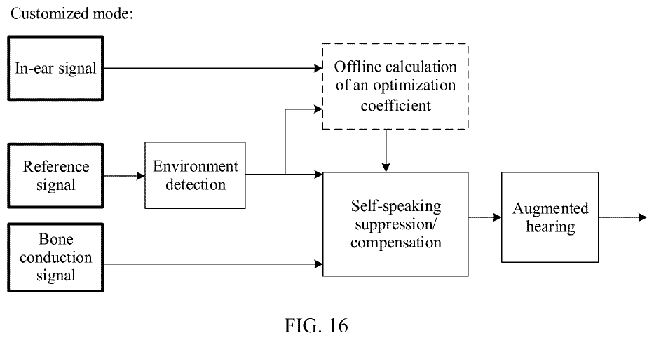

For the foregoing embodiment in which signal processing is performed with reference to error microphone, for example, FIG. 16 is another example diagram of a headset algorithm architecture according to an embodiment of this application. As shown in FIG. 16, with reference to FIG. 14, when the headset performs signal processing in the customized mode, the headset further obtains in-ear signals, for example, the sound signal D and the sound signal E based on FIG. 11 or FIG. 9. The headset may perform, based on the in-ear signal, offline calculation to obtain an optimization coefficient, that is, to obtain the frequency response difference. The offline calculation means that the headset performs processing shown in FIG. 16 only each time the customized mode is enabled. In other words, after the frequency response difference is obtained and before the user stops using the headset, augmented hearing is implemented based on the frequency response difference. According to the signal processing provided in this embodiment of this application, a more natural effect of the sound signal of the user in the first signal heard by the user is implemented.

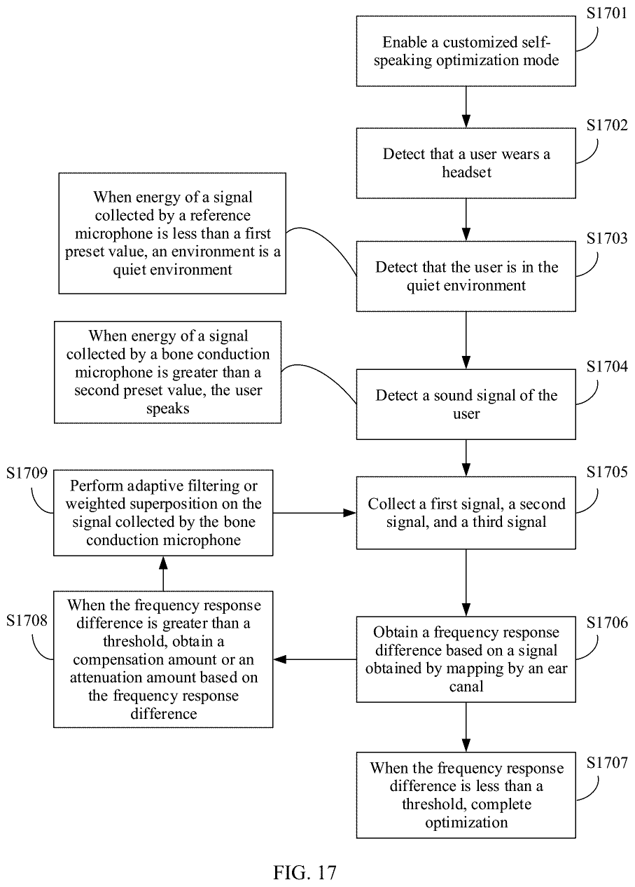

With reference to FIG. 14 to FIG. 16, for example, FIG. 17 is another example flowchart of a signal processing method according to an embodiment of this application. As shown in FIG. 17, the method may include the following steps.

S1701: Enable a customized self-speaking optimization mode.

S1702: Detect that the user wears the headset.

S1703: Detect that the user is in the quiet environment.

S1704. Detect the sound signal of the user.

S1701 to S1704 are similar to content having a same function as that in the embodiment in FIG. 14. For a same part, refer to descriptions in the embodiment in FIG. 14. Details are not described herein again. A difference lies in that S1701 to S1704 are steps performed by the headset when the user selects the customized mode. S1703 may specifically include: When energy of the signal collected by the reference microphone of the headset is less than a first preset value, the environment is a quiet environment. S1704 may specifically include: When energy of the signal collected by the bone conduction microphone is greater than a second preset value, the user speaks. When the user speaks, the sound signal of the user is detected. The bone conduction microphone is the bone conduction sensor. For example, the energy of any signal may include: an integral of square of amplitudes of signals in the frequency domain, or a sum of square of amplitudes of signals in the frequency domain.

S1705: Collect the first signal, the second signal, and the third signal.

S1706: Obtain a frequency response difference based on a signal obtained by mapping by an ear canal.

For details of S1705 and S1706, refer to related descriptions of third signal collection and frequency response difference obtaining in the optional embodiment in FIG. 14. Details are not described herein again.

S1707: Complete optimization when the frequency response difference is less than a threshold.

After obtaining the frequency response difference, the headset may compare the frequency response difference with the threshold. If the frequency response difference is less than the threshold, it indicates that after the first signal is mapped by the ear canal of the user, the sound signal of the user in the first signal heard by the user is similar to hearing perception when the user does not wear the headset, and optimization may not be performed. Correspondingly, the headset may determine that optimization is completed, that is, augmented hearing shown in FIG. 16 is completed, and the target signal may be played.

S1708: When the frequency response difference is greater than the threshold, obtain the compensation amount or the attenuation amount based on the frequency response difference.

If the headset determines that the frequency response difference is greater than the threshold, it indicates that after the first signal is mapped by the ear canal of the user, there is a difference that is between the sound signal of the user in the first signal heard by the user and hearing perception of the user when the user does not wear the headset and that makes the hearing perception unnatural, and optimization may be performed through step S1709. For details of obtaining the compensation amount or the attenuation amount based on the frequency response difference, refer to the descriptions of obtaining the compensation amount or the attenuation amount in the optional embodiment in FIG. 14. Details are not described herein again.

S1709: Perform adaptive filtering or weighted superposition on the signal collected by the bone conduction microphone.

S1709 is specifically equivalent to that the hearing aid apparatus processes the sound signal of the user in the first signal based on the first signal, the second signal, and the frequency response difference, to obtain the target signal. For details, refer to the foregoing related descriptions. Details are not described herein again.

In a case, before the user stops using the headset, S1705 may be performed each time after the target signal is played, to continuously optimize the sound signal of the user in a process in which the user wears the headset, that is, a process in which the user uses the headset. It may be understood that, in the continuous optimization process, S1706 may be performed, or the embodiments in FIG. 9 and FIG. 11 may be performed. This specifically depends on a mode selection operation performed by the user on the mobile phone.

In this embodiment of this application, a signal processing result applicable to an ear canal structure of the user can be obtained based on a frequency response difference between path mapping results of the reference microphone and the error microphone, so that customization of signal processing for different users is further improved, and it is ensured that the signal processing result is more applicable to the user.

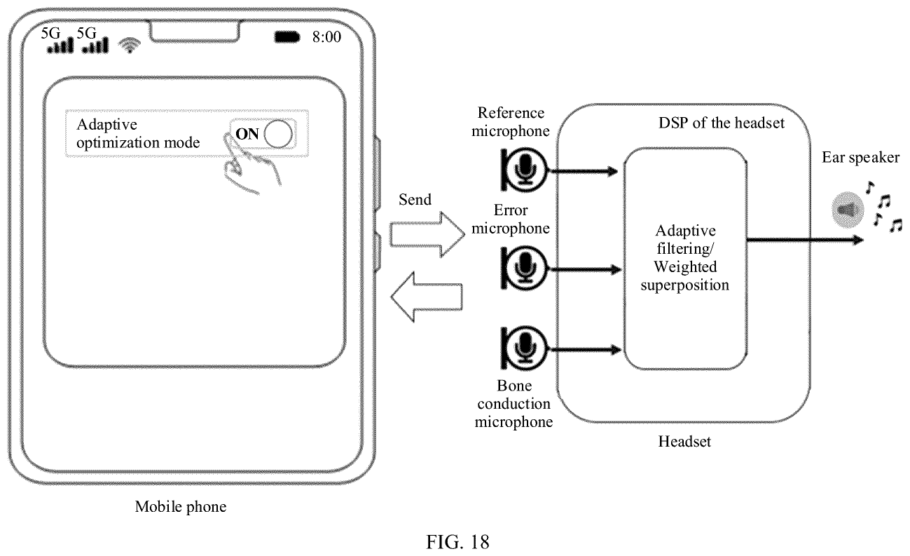

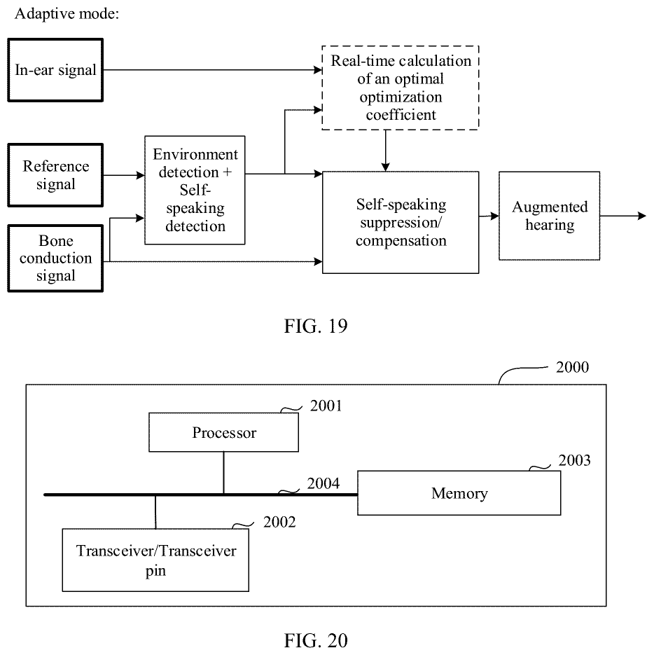

As shown in FIG. 12a or FIG. 12b, after displaying the mode selection interface, if detecting the enable operation on the adaptive mode selection control, the mobile phone may send the adaptive mode enable signal to the headset. Further, when receiving the adaptive mode enable signal sent by the target terminal, the headset detects, via the first sensor, whether the user wears the hearing aid apparatus. For example, FIG. 18 is another example flowchart of a signal processing method according to an embodiment of this application. As shown in FIG. 18, the user may slide an enable button to an “ON” state, to enable an adaptive optimization mode. In this case, the mobile phone detects the enable operation on the adaptive mode selection control. With reference to FIG. 18, FIG. 19 is another example diagram of a headset algorithm architecture according to an embodiment of this application. As shown in FIG. 19, when an adaptive mode enable signal sent by the mobile phone is received, the headset performs signal processing in an adaptive mode. The signal processing in the adaptive mode is similar to the signal processing in the customized mode in FIG. 16, and a difference lies in that the optimization coefficient is obtained through real-time calculation. The real-time calculation means that when the headset detects, through environment detection and self-speaking detection, that the user is in a quiet environment and emits a sound signal, the headset calculates the optimization coefficient based on an in-ear signal, a reference signal, and a bone conduction signal. The optimization coefficient is the compensation amount or the attenuation amount in the foregoing embodiments. For a same part, details are not described herein again. For details, refer to the descriptions of the embodiment in FIG. 16.

It may be understood that, in an optional implementation, execution of the embodiment in FIG. 19 may be: After playing a target signal through a speaker, the hearing aid apparatus performs a step of detecting, via the first sensor, whether the user wears the hearing aid apparatus, and further performing a step of calculating the optimization coefficient in real time. In this way, it can be ensured that the user wears the headset during optimization, so that invalid signal processing is avoided.

In embodiments of this application, each time the user wears the headset, the headset may dynamically adjust, in the adaptive mode, optimization strength of the sound signal of the user in the first signal, so that a problem of an inconsistent optimization effect caused by a wearing difference can be avoided, and the user does not need to perform manual adjustment. Online correction may be performed, that is, the compensation amount or attenuation amount are calculated in real time, so that a sound signal optimization effect applicable to the current user is provided in real time.

It should be understood that, to implement the foregoing functions, the electronic device includes corresponding hardware and/or software modules for performing the functions. With reference to the example algorithm steps described in the embodiments disclosed in this specification, embodiments of this application can be implemented in a form of hardware or a combination of hardware and computer software. Whether a function is performed by hardware or hardware driven by computer software depends on particular applications and design constraints of the technical solutions. A person skilled in the art may use different methods to implement the described functions for each particular application with reference to the embodiments, but it should not be considered that the implementation goes beyond the scope of embodiments of this application.

In this embodiment, the electronic device may be divided into function modules based on the foregoing method examples. For example, each function module may be obtained through division based on each corresponding function, or two or more functions may be integrated into one processing module. The integrated module may be implemented in a form of hardware. It should be noted that, in this embodiment, division into the modules is an example, is merely logical function division, and may be other division during actual implementation.

In an example, FIG. 20 is a block diagram of an apparatus 2000 according to an embodiment of this application. As shown in FIG. 20, the apparatus 2000 may include a processor 2001 and a transceiver/transceiver pin 2002, and optionally, further include a memory 2003.

Components of the apparatus 2000 are coupled together through a bus 2004. In addition to a data bus, the bus 2004 further includes a power bus, a control bus, and a status signal bus. However, for clear description, various buses are referred to as the bus 2004 in the figure.

Optionally, the memory 2003 may be configured to store instructions in the foregoing method embodiments. The processor 2001 may be configured to execute the instructions in the memory 2003, control a receiving pin to receive a signal, and control a sending pin to send a signal.

The apparatus 2000 may be the electronic device or a chip of the electronic device in the foregoing method embodiments.

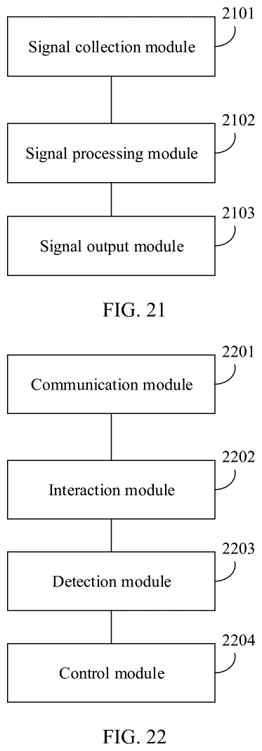

For example, FIG. 21 is a block diagram of a hearing aid apparatus 2100 according to an embodiment of this application. As shown in FIG. 21, the hearing aid apparatus 2100 may include:
a signal collection module 2101, configured to collect a first signal and a second signal when it is detected that a user wears the hearing aid apparatus and the user makes a sound, where the first signal includes a sound signal of the user and a surrounding ambient sound signal, and the second signal includes the sound signal of the user;
a signal processing module 2102, configured to process the sound signal of the user in the first signal based on the first signal and the second signal, to obtain a target signal; and
a signal output module 2103, configured to play the target signal through an ear speaker.

For example, FIG. 22 is a block diagram of a device control apparatus 2200 according to an embodiment of this application. As shown in FIG. 22, used in a terminal, the device control apparatus 2200 may include:
a communication module 2201, configured to establish a communication connection to a hearing aid apparatus, where the hearing aid apparatus is configured to perform the signal processing method according to any one of the foregoing implementations;
an interaction module 2202, configured to display a parameter adjustment interface, where the parameter adjustment interface includes at least one of the following setting controls: an adjustment degree setting control and a frequency band range setting control;
a detection module 2203, configured to detect an operation on the adjustment degree setting control and an operation on the frequency band range setting control, to obtain at least one of a degree correction amount and a frequency band range; and
a control module 2204, configured to send at least one of the degree correction amount and the frequency band range to the hearing aid apparatus, where the hearing aid apparatus processes a sound signal of a user in a first signal based on at least one of the degree correction amount and the frequency band range, to obtain a target signal.

All related content of the steps in the foregoing method embodiments may be cited in function descriptions of the corresponding function modules. Details are not described herein again.

This embodiment further provides a computer storage medium. The computer storage medium stores computer instructions. When the computer instructions are run on an electronic device, the electronic device is enabled to perform the related method steps, to implement a cross-device stream forwarding control method for a large screen service in the foregoing embodiments.

This embodiment further provides a computer program product. When the computer program product is run on a computer, the computer is enabled to perform the foregoing related steps, to implement a cross-device stream forwarding control method for a large screen service in the foregoing embodiments.

In addition, an embodiment of embodiments of this application further provides an apparatus. The apparatus may be specifically a chip, a component, or a module. The apparatus may include a processor and a memory that are connected to each other. The memory is configured to store computer-executable instructions. When the apparatus runs, the processor may execute the computer-executable instructions stored in the memory, to enable the chip to perform a cross-device stream forwarding control method for a large screen service in the foregoing method embodiments.

The electronic device, the computer storage medium, the computer program product, or the chip provided in this embodiment is configured to perform the corresponding method provided above. Therefore, for beneficial effects that can be achieved, refer to the beneficial effects of the corresponding method provided above. Details are not described herein again.

The foregoing descriptions about implementations allow a person skilled in the art to understand that, for the purpose of convenient and brief description, division into the foregoing function modules is taken as an example for illustration. During actual application, the foregoing functions can be allocated to different modules and implemented according to a requirement, that is, an inner structure of an apparatus is divided into different function modules to implement all or some of the functions described above.

In several embodiments provided in embodiments of this application, it should be understood that the disclosed apparatus and method may be implemented in other manners. For example, the described apparatus embodiment is merely an example. For example, division into the modules or the units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, function units in embodiments of this application may be integrated into one processing unit, or each of the units may exist alone physically, or two or more units may be integrated into one unit. The integrated unit may be implemented in a form of hardware, or may be implemented in a form of a software function unit.

Any content of embodiments of this application and any content of a same embodiment may be freely combined. Any combination of the foregoing content shall fall within the scope of embodiments of this application.

When the integrated unit is implemented in a form of a software function unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in the form of a software product. The software product is stored in a storage medium and includes several instructions for instructing a device (which may be a single-chip microcomputer, a chip or the like) or a processor (processor) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing describes embodiments of this application with reference to the accompanying drawings. However, embodiments of this application are not limited to the foregoing specific implementations. The foregoing specific implementations are merely examples instead of limiting. A person of ordinary skill in the art, under the teachings of embodiments of this application, may further make many modifications without departing from the purpose of embodiments of this application and the protection scope of the claims, and all of the modifications fall within the protection of embodiments of this application.

1. A signal processing method, applied to a hearing aid apparatus, wherein the method comprises:
collecting a first signal and a second signal when it is detected that a user wears the hearing aid apparatus and the user makes a sound, wherein the first signal comprises a sound signal of the user and a surrounding ambient sound signal, and the second signal comprises the sound signal of the user;
processing the sound signal of the user in the first signal based on the first signal and the second signal to obtain a target signal; and
playing the target signal through an ear speaker.

2. The method according to claim 1, wherein the processing the sound signal of the user in the first signal based on the first signal and the second signal to obtain a target signal comprises:
filtering the first signal based on the second signal to obtain a filtering gain; and
performing attenuation processing on the sound signal of the user in the first signal based on the filtering gain to obtain the target signal.

3. The method according to claim 2, wherein the filtering the first signal based on the second signal to obtain a filtering gain comprises:
filtering the sound signal of the user in the first signal based on the second signal to obtain an expected signal; and
calculating a ratio of the expected signal to the first signal to obtain the filtering gain.

4. The method according to claim 2, wherein the filtering the first signal based on the second signal to obtain a filtering gain comprises:
filtering the first signal based on the second signal to obtain an original filtering gain;
obtaining at least one of a degree correction amount or a frequency band range; and at least one of:
adjusting a magnitude of the original filtering gain based on the degree correction amount to obtain the filtering gain; or
adjusting, based on the frequency band range, a frequency band on which the original filtering gain is enabled to obtain the filtering gain.

5. The method according to claim 1, wherein the processing the sound signal of the user in the first signal based on the first signal and the second signal to obtain a target signal comprises:
enhancing the first signal based on the second signal to obtain a compensated signal; and
performing enhancement processing on the sound signal of the user in the first signal based on the compensated signal to obtain the target signal.

6. The method according to claim 5, wherein the enhancing the first signal based on the second signal to obtain a compensated signal comprises:
determining a weighting coefficient of the second signal;
obtaining an enhanced signal based on the weighting coefficient and the second signal; and
loading the enhanced signal to the first signal to obtain the compensated signal.

7. The method according to claim 5, wherein the enhancing the first signal based on the second signal to obtain a compensated signal comprises:
obtaining at least one of a degree correction amount or a frequency band range; and at least one of:
enhancing the first signal based on signal compensation strength indicated by the degree correction amount and the second signal to obtain the compensated signal; or
enhancing, based on the second signal, the first signal belonging to the frequency band range to obtain the compensated signal.

8. The method according to claim 4, wherein the obtaining at least one of a degree correction amount or a frequency band range comprises:
establishing a communication connection to a target terminal, wherein the target terminal is configured to display a parameter adjustment interface, and the parameter adjustment interface comprises at least one of an adjustment degree setting control or a frequency band range setting control; and
receiving at least one of the degree correction amount or the frequency band range, wherein the at least one of the degree correction amount or the frequency band range is sent by the target terminal, wherein the degree correction amount is obtained by the target terminal by detecting an operation on the adjustment degree setting control and wherein the frequency band range is obtained by the target terminal by detecting an operation on the frequency band range setting control.

9. The method according to claim 8, wherein the parameter adjustment interface comprises a left-ear adjustment interface and a right-ear adjustment interface, and wherein the receiving at least one of the degree correction amount or the frequency band range that is sent by the target terminal comprises:
receiving at least one of left-ear correction data or right-ear correction data that is sent by the target terminal, wherein the left-ear correction data is obtained by the target terminal by detecting an operation on a setting control on the left-ear adjustment interface, and the right-ear correction data is obtained by the target terminal by detecting an operation on a setting control on the right-ear adjustment interface, wherein the left-ear correction data comprises at least one of a left-ear degree correction amount or a left-ear frequency band range, and wherein the right-ear correction data comprises at least one of a right-ear degree correction amount or a right-ear frequency band range; and
selecting, based on an ear identifier carried in at least one of the left-ear correction data or the right-ear correction data, correction data corresponding to an ear that is the same as an ear in which the hearing aid apparatus is located.

10. The method according to claim 1, wherein the collecting a first signal and a second signal when it is detected that a user wears the hearing aid apparatus and the user makes a sound comprises:
detecting, via a first sensor, whether the user wears the hearing aid apparatus;
detecting, via a third sensor, whether the user is in a quiet environment if the user wears the hearing aid apparatus;
detecting, via a second sensor, whether the user makes the sound if the user is in the quiet environment; and
collecting the first signal and the second signal if the user makes the sound.

11. A device control method, applied to a terminal, wherein the method comprises:
establishing a communication connection to a hearing aid apparatus, wherein the hearing aid apparatus is configured to perform operations comprising:
collecting a first signal and a second signal when it is detected that a user wears the hearing aid apparatus and the user makes a sound, wherein the first signal comprises a sound signal of the user and a surrounding ambient sound signal, and the second signal comprises the sound signal of the user;
processing the sound signal of the user in the first signal based on the first signal and the second signal to obtain a target signal; and
playing the target signal through an ear speaker;
displaying a parameter adjustment interface, wherein the parameter adjustment interface comprises at least one of an adjustment degree setting control or a frequency band range setting control, wherein the method comprises at least one of:
detecting an operation on the adjustment degree setting control to obtain a degree correction amount; or
detecting an operation on the frequency band range setting control to obtain a frequency band range; and
sending at least one of the degree correction amount or the frequency band range to the hearing aid apparatus, wherein the hearing aid apparatus processes the sound signal of the user in the first signal based on at least one of the degree correction amount or the frequency band range to obtain the target signal.

12. The method according to claim 11, wherein the adjustment degree setting control comprises a plurality of geometric graphs that have a same shape but have different dimensions, each of the plurality of geometric graphs indicates a correction amount, and a larger correction amount indicates a larger dimension of the geometric graph, and the frequency band range setting control comprises a frequency band range icon and a slider located on the frequency band range icon, and wherein:
the detecting an operation on the adjustment degree setting control to obtain a degree correction amount comprises:
detecting a tap operation on the plurality of geometric graphs on the adjustment degree setting control; and
determining, as the degree correction amount, a correction amount indicated by the geometric graph on which the tap operation is detected; or
the detecting an operation on the frequency band range setting control to obtain a frequency band range comprises:
detecting a sliding operation on the slider on the frequency band range setting control; and
determining the frequency band range based on a sliding location of the slider.

13. The method according to claim 11, wherein the parameter adjustment interface comprises a left-ear adjustment interface and a right-ear adjustment interface, and wherein the method comprises:
detecting an operation on a setting control on the left-ear adjustment interface to obtain left-ear correction data, wherein the left-ear correction data comprises at least one of a left-ear degree correction amount or a left-ear frequency band range; and
detecting an operation on a setting control on the right-ear adjustment interface to obtain right-ear correction data, wherein the right-ear correction data comprises at least one of a right-ear degree correction amount or a right-ear frequency band range.

14. The method according to claim 11, wherein the displaying a parameter adjustment interface comprises:
displaying a mode selection interface, wherein the mode selection interface comprises a self-speaking optimization mode selection control; and
when an enable operation on the self-speaking optimization mode selection control is detected, displaying the parameter adjustment interface.

15. The method according to claim 11, wherein before the displaying a parameter adjustment interface, the method further comprises:
displaying a mode selection interface, wherein the mode selection interface comprises at least one of a customized mode selection control or an adaptive mode selection control; and at least one of:
when an enable operation on the customized mode selection control is detected, sending a customized mode enable signal to the hearing aid apparatus, wherein the customized mode enable signal indicates the hearing aid apparatus to detect, via a first sensor, whether the user wears the hearing aid apparatus; or
when an enable operation on the adaptive mode selection control is detected, sending an adaptive mode enable signal to the hearing aid apparatus, wherein the adaptive mode enable signal indicates the hearing aid apparatus to detect, via the first sensor, whether the user wears the hearing aid apparatus.

16. The method according to claim 15, wherein after the sending a customized mode enable signal to the hearing aid apparatus, the method further comprises:
receiving an information display instruction sent by the hearing aid apparatus, wherein the information display instruction is sent by the hearing aid apparatus when detecting that the user is in a quiet environment; and
displaying prompt information, wherein the prompt information is used to guide the user to make a sound.

17. The method according to claim 16, wherein before the displaying prompt information, the method further comprises:
receiving a first completion instruction sent by the hearing aid apparatus, wherein the first completion instruction is sent by the hearing aid apparatus when detecting that the user wears the hearing aid apparatus; and
receiving a second completion instruction sent by the hearing aid apparatus, wherein the second completion instruction is sent by the hearing aid apparatus when detecting that the user is in the quiet environment, wherein after the displaying prompt information, the method further comprises:
receiving a third completion instruction sent by the hearing aid apparatus, wherein the third completion instruction is sent by the hearing aid apparatus when the hearing aid apparatus obtains the target signal; and
outputting at least one of information indicating that detection is completed or information indicating that a customized parameter is generated.

18. An electronic device, comprising:
at least one processor; and
one or more memories coupled to the at least one processor and storing programming instructions for execution by the at least one processor to perform operations comprising:
collecting a first signal and a second signal when it is detected that a user wears the hearing aid apparatus electronic device and the user makes a sound, wherein the first signal comprises a sound signal of the user and a surrounding ambient sound signal, and the second signal comprises the sound signal of the user;
processing the sound signal of the user in the first signal based on the first signal and the second signal to obtain a target signal; and
playing the target signal through an ear speaker.

19. The electronic device according to claim 18, wherein the processing the sound signal of the user in the first signal based on the first signal and the second signal to obtain a target signal comprises:
filtering the first signal based on the second signal to obtain a filtering gain; and
performing attenuation processing on the sound signal of the user in the first signal based on the filtering gain, to obtain the target signal.

20. The electronic device according to claim 19, wherein the filtering the first signal based on the second signal to obtain a filtering gain comprises:
filtering the sound signal of the user in the first signal based on the second signal to obtain an expected signal; and
calculating a ratio of the expected signal to the first signal, to obtain the filtering gain.
